(19) United States
(12) Patent Application Publication
(10) Pub. No.: US 2026/0242112 A1
(43) Pub. Date: Aug. 20, 2026

(54) LAMINATED BIODEGRADABLE FILM FOR PACKAGING PHARMACEUTICAL COMPOSITIONS

(71) Applicant: Boehringer Ingelheim Vetmedica GmbH, Ingelheim am Rhein (DE)

(72) Inventors: Chandana Kolluru, Suwanee, GA (US); Jason Locklin, Athens, GA (US); Mark Allen Bennett, Seneca, SC (US)

(21) Appl. No.: 19/345,259

(22) Filed: Sep. 30, 2025

Related U.S. Application Data
(60) Provisional application No. 63/702,265, filed on Oct. 2, 2024.

(51) Int. Cl. B65D 75/30; A61J 1/14; B32B 7/12; B32B 23/08; B65D 65/46

(52) U.S. Cl. CPC B65D 75/30; A61J 1/1468; B32B 7/12; B32B 23/08; B65D 65/466; B32B 2255/10; B32B 2255/205; B32B 2255/24; B32B 2307/7163; B32B 2307/7244; B32B 2307/7246; B32B 2307/7376; B32B 2439/46

(57) ABSTRACT

Biodegradable films and pouches (“sachets”) suitable for packaging pharmaceutical formulations, e.g., vaccines. The biodegradable films and sachets contain a top layer of cellophane, an adhesive layer, and a seal layer. These layers facilitate maintenance of active ingredient viability. The top layer includes cellophane for barrier protection, while the seal layer incorporates food-grade polybutylene derivatives. The films can be made into pouches by joining a front and a back composite material at a peripheral edge to form an internal compartment that encloses the pharmaceutical formulations. The biodegradable films are compostable in soil and safe for animal consumption. The biodegradable pouches are useful for vaccinating wildlife population, such as racoons.

### FIELD OF THE INVENTION

This invention is generally in the field of biodegradable packages.

### BACKGROUND OF THE INVENTION

RABORAL V-RG® is a robust, cost-effective system for immunizing wildlife population. RABORAL V-RG® is packaged in sachets, and delivered in the format of Fish Meal Polymer (FMP) block baits or coated sachet (CS). However, the plastic film used in current sachet for both delivery formats negatively impacts the environment. For each CS or FMP distributed in the field, 0.2 grams (g) of plastic sachet packaging ends up in the field. In 2018, there were 7,919,200 doses of RABORAL V-RG® sold in US market, meaning that 1,584 kg of plastic ended up in the field, without any end-of-life treatment. This is equivalent to 160,000 plastic bottles (16.9 oz size). If the distribution area is close to water sources, it is very likely to cause plastic pollution in rivers/ocean.

There remains a need to develop improved material and packing system for vaccinating wildlife population.

### SUMMARY OF THE INVENTION

It is the object of the present invention to provide improved materials and packing systems for protecting pharmaceutical formulations, which are environmentally friendly.

It is a further object of the present invention to provide improved materials and packing systems for vaccinating wildlife population, which are environmentally friendly.

Biodegradable films, pouches (also referred to herein as “sachets”), and methods of using thereof are described herein. The biodegradable film and pouches thereof are soil compostable, are safe for consumption by animals, and can provide moisture and gas barrier properties for maintaining the viability of actives in a pharmaceutical formulation.

The biodegradable film is a composite material containing a top layer, an adhesive layer, and a seal layer. The adhesive layer is between and in contact with each of the top layer and seal layer. The top layer contains cellophane, which can provide moisture and gas barrier properties for maintaining the viability of actives in a pharmaceutical formulation, such as the viral titers of a vaccine. The seal layer contains polybutylene succinate adipate or polybutylene adipate terephthalate, which is food contact grade and is compatible with the pharmaceutical formulation, such as an oral recombinant rabies vaccine. The adhesive layer is typically formed by an aqueous-based adhesive, such as polyurethane.

The properties of the biodegradable films make them particularly useful as packaging materials for pharmaceutical formulations. In some forms, biodegradable pouches for protecting a pharmaceutical formulation can be formed using the biodegradable films. The biodegradable pouch contains a front biodegradable film (also referred to herein as “a front composite material”) and a back biodegradable film (also referred to herein as a “back composite material”). The front and back composite materials are joined at a peripheral edge, forming an internal compartment. The pharmaceutical formulation is in the internal compartment and is enclosed within the pouch. Thus, the biodegradable pouches are vaccine compatible and have sufficient barrier properties to protect the pharmaceutical formulations contained therein.

For example, the biodegradable pouches can maintain (e.g., a change of less than 1.0) the virus titers of a liquid vaccine, following storage for at least 7 days, at least 14 days, or at least 21 days, at about 30° C. and 1 standard atmosphere (atm); or following storage at least 1 month, at least 3 months, at least 6 months, at least 9 months, at least 12 months, at least 18 months, or at least 24 months, at about 5° C. and 1 atm.

For example, the biodegradable pouches can maintain (i.e., no statistical change) the properties (e.g., hardness, adhesiveness, cohesiveness, elasticity, gumminess, and/or chewability) of a soft chew, following storage for at least 1 months, at least 2 months, or at least 3 months, at about 24° C. or 40° C. and 1 atm.

Optionally, the biodegradable pouch can contain an outer coating of a bait material, such as bait made from a fruit, a vegetable, a nut butter (e.g., peanut butter), marshmallow, bacon, cat food, fish, or birdseed, or a combination thereof, for attracting wild animals.

The biodegradable pouches are particularly useful for vaccinating wildlife population, such as racoons. For example, the biodegradable pouches containing liquid vaccines are distributed in a forest or a neighborhood at a desired distribution density. Wild animals, such as racoons, can be attracted by the bait material coated on the outer surface of the biodegradable pouch, bite into the biodegradable pouch, consume the liquid vaccine in the biodegradable pouch, and thereby get vaccinated.

### BRIEF DESCRIPTION OF THE DRAWINGS

FIG. 1 is a bar graph summarizing the mean of Vaccinia Recombinant Glycoprotein (VRG) titers versus time (days) for the samples: metallized-coated Natureflex sachets (also referred to herein as “m-PBSA sachets”), clear-coated Natureflex sachets (also referred to herein as “c-PBSA sachets”), and control polyethylene sachets.

FIG. 2 is a line graph of the average cumulative CO₂ production (mg) for all samples (triplicates in each sample) over time (days) until day 182.

FIG. 3 is a line graph of the average absolute biodegradation percentages for all samples (triplicates in each sample) over time (days) until day 182.

FIG. 4 is a line graph of the relative biodegradation percentages (average biodegradation relative to the positive control (cellulose)) for all samples (triplicates in each sample) over time (days) until day 182. During the colonization phase, the values for relative biodegradation are subject to high fluctuation.

FIG. 5 is a schematic representation of the set-up used for the baiting offering at the outdoor animal research facility of National Wildlife Research Center (NWRC).

FIG. 6 is a box plot of the animal interaction score across the four different trials for round 1 comparing Bait A, standard sachet, and Bait B, metallic bait. A score of 4 was associated with an unlocated bait (assumed completed consumption) and a score of 1 was untouched without any interaction observed.

FIG. 7 is a box plot of the animal interaction score across the four different trials for round 1 comparing Bait A, standard sachet, and Bait C, the clear bait. A score of 4 was associated with an unlocated bait (assumed completed consumption) and a score of 1 was untouched without any interaction observed.

FIG. 8 is a dot blot showing the hardness (N) of the Ora Vet® chew packaged in the original packaging, c-PBSA packaging or without packaging (negative control). Individual standard deviations were used to calculate the intervals.

FIG. 9 is a dot blot showing the adhesiveness of the OraVet® chew packaged in the original packaging, c-PBSA packaging or without packaging (negative control). Individual standard deviations were used to calculate the intervals.

FIG. 10 is a dot blot showing the cohesiveness of the OraVet® chew packaged in the original packaging, c-PBSA packaging or without packaging (negative control). Individual standard deviations were used to calculate the intervals.

FIG. 11 is a dot blot showing the elasticity of the OraVet® chew packaged in the original packaging, c-PBSA packaging or without packaging (negative control). Individual standard deviations were used to calculate the intervals.

FIG. 12 is a dot blot showing the gumminess of the Ora Vet® chew packaged in the original packaging, c-PBSA packaging or without packaging (negative control). Individual standard deviations were used to calculate the intervals.

FIG. 13 is a dot blot showing the chewability of the OraVet® chew packaged in the original packaging, c-PBSA packaging or without packaging (negative control). Individual standard deviations were used to calculate the intervals.

FIG. 14 is a schematic of the method for manufacturing the sachets. Sachets were manufactured on a Vertical Form Fill Seal (VFFS) machine, by adjusting the seal temperature, pressure, and cycles per min (cpm) based on the type of film used.

FIG. 15 is a cross-sectional view of an exemplary pouch.

FIG. 16 is a cross-sectional view of an exemplary top layer of a biodegradable film.

### DETAILED DESCRIPTION OF THE INVENTION

### I. Biodegradable Films and Pouches

The biodegradable film described herein is a composite material containing a top layer, an adhesive layer, and a seal layer. The adhesive layer is between and in contact with each of the top layer and seal layer.

Biodegradable pouches for protecting pharmaceutical formulations can be formed by one or more biodegradable films. For example, a biodegradable pouch contains a front biodegradable film and a back biodegradable film, which are joined at a peripheral edge, forming an internal compartment. The pharmaceutical formulation is in the internal compartment and is enclosed within the pouch. Optionally, the biodegradable pouch contains an outer coating containing a bait material for attracting wildlife.

The biodegradable pouch and internal compartment can have any suitable dimensions, such as pouch dimensions of 1.3 inches by 4 inches and internal compartment dimensions of 1.25 inches by 0.75 inches. The internal compartment can have suitable dimensions to accommodate approximately from about 0.5 mL to about 5.0 mL of a liquid vaccine, such as a rabies vaccine. Optionally, the internal compartment has suitable dimensions to accommodate from about 0.5 mL to about 4.0 mL, from about 0.5 mL to about 3.5 mL, from about 0.5 mL to about 3.0 mL, from about 0.5 mL to about 2.5 mL, from about 0.5 mL to about 2.0 mL, or from about 0.5 mL to about 1.8 mL, from about 0.5 mL to about 1.7 mL, from about 0.5 mL to about 1.6 mL, or from about 0.5 mL to about 1.5 mL of a liquid vaccine e.g., a rabies vaccine, such as from 1.6 to 2.0 mL of a liquid vaccine. The specific dimensions of the pouch and the internal compartment can be selected based on the specific pharmaceutical formulations for administration, storage conditions, distribution site and conditions, target animals, etc.

The biodegradable pouches are compatible with the pharmaceutical formulation (i.e., do not adversely affect the activity and effectiveness of the pharmaceutical formulation) and have sufficient barrier properties to protect the pharmaceutical formulations contained therein (e.g., the activity of actives in the pharmaceutical formulation and/or texture of the pharmaceutical formulation are maintained).

An exemplary biodegradable pouch, which contains a liquid vaccine, are illustrated in FIG. 15. As shown in FIG. 15, the biodegradable pouch 100 contains a front biodegradable film 110 and a back biodegradable film 130. The front and back biodegradable films are joined at a peripheral edge (not illustrated), such as by heat staking or adhesives, as is known to those in the art, forming an internal compartment 170. The liquid vaccine (not illustrated) is in the internal compartment 170 and is enclosed within the pouch 100. As shown in FIG. 15, each of the front 110 and back 130 biodegradable films contains a top layer 10, an adhesive layer 20, and a seal layer 30. The adhesive layer 20 is between and in contact with each of the top layer 10 and seal layer 30. Generally, the top layer 10 is the outermost layer of each biodegradable film of the biodegradable pouch 100; while the seal layer 30 is the innermost layer of each biodegradable film of the biodegradable pouch 100. The seal layers of the front 110 and back 130 biodegradable films form the wall of the internal compartment 170, and thus a surface of the seal layer may be in direct contact with the pharmaceutical formulation 190 enclosed therein. For example, the pharmaceutical formulation is a liquid vaccine and the surface of the seal layer facing the internal compartment is in contact with the liquid vaccine. For example, the pharmaceutical formulation is a soft chew and at least a portion of the surface of the seal layer facing the internal compartment is in contact with the soft chew.

### I-A. Biodegradable Film

The biodegradable film forming the pouch is a composite material containing a top layer, an adhesive layer, and a seal layer. The adhesive layer is between and in contact with each of the top layer and seal layer.

The multilayer composite material can be manufactured by any suitable method, such as lamination processes, for example, extrusion lamination or dry lamination. For example, the composite material can be manufactured by extrusion lamination, which includes extruding a molten polymeric layer, which adheres and penetrates another layer, and optionally includes an anchoring coating disposed between the two layers, which is pressed between two nip rollers. The composite material may be manufactured by dry lamination, which includes the use of an adhesive, which may be a water-based adhesive, for example, EPOTAL Eco, by BASF Corp., applied to either the top or seal layer, pressing the top layer and seal layer together between rollers, for example, at 10-18 MPa and a temperature ranging from approximately 70-120° C. and a roll speed of for example, 8-50 meter/minute (m/minute) and driving off a solvent, i.e., water, within the adhesive, to form the composite material. The composite material can have additional layers added by repeating either lamination process to incorporate the additional layer. Coatings may be added on any one of the layers of the composite material, such as an outer coating or a metallic coating, as described herein, by a suitable method known in the art, such as sputter coating, rolling, spraying, etc. In some forms, calendaring processes can also be used to join several layers to form a composite material. Optionally, the manufacture processes for the composite material does not include infrared radiation.

### I-A-1. Top Layer

Generally, the top layer of each biodegradable film forms the outermost layer of the biodegradable pouch. The top layer contains cellophane.

The cellophane of the top layer is a material formed by a natural or synthetic cellulose, such as cellulose from wood, cotton, hemp, or other suitable sources, and has low permeability to air, oils, greases, bacteria, and liquid water. Accordingly, the top layer can provide moisture and gas barrier properties for maintaining the viability of actives in a pharmaceutical formulation, such as the viral titers of a vaccine.

The top layer of each biodegradable film can have any suitable thickness, depending on the specific pharmaceutical formulations being packaged, storage conditions, distribution site and conditions, target animals, etc. In some forms, the top layer can have a thickness ranging from about 10 μm to about 200 μm, from about 10 μm to about 150 μm, from about 10 μm to about 120 μm, from about 10 μm to about 100 μm, from about 10 μm to about 50 μm, from about 10 μm to about 30 μm, for example, about 20 μm.

I-A-1-a. Moisture Barrier Heat-Seal Coating

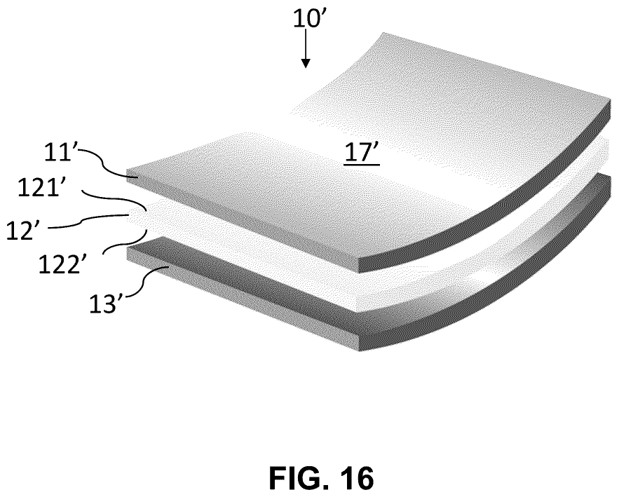

In some forms, the top layer further contains two moisture barrier heat-seal coatings, disposed on the top and/or bottom surfaces of the cellophane. For example, as shown in FIG. 16, the top layer 10′ contains a first moisture barrier heat-seal coating 11′ on the top surface 121′ of the cellophane 12′, and a second moisture barrier heat-seal coating 13′ on the bottom surface 122′ of the cellophane 12′. In some forms, the top layer 10′ contains the first moisture barrier heat-seal coating 11′ on the top surface 121′ of the cellophane 12′, but does not contain the second moisture barrier heat-seal coating 13′ on the bottom surface 122′ of the cellophane 12′. Referring to FIG. 15, when only the first moisture barrier heat-seal coating 11′ (but not the second moisture barrier heat-seal coating 13′) presents, the first moisture barrier heat-seal coating 11′ is placed on the top surface (facing outward) of the top layer 10 of the front biodegradable film 110 and below the bottom surface (facing outward) of the top layer 10 of the back biodegradable film 130 of the biodegradable pouch 100. The moisture barrier heat-seal coating can be formed by any suitable material such as polyvinylidene dichloride (PVDC). In some forms, each of the first and second moisture barrier heat-seal coatings 11′ and 13′ can have a thickness ranging from about 1 μm to about 20 μm, from about 1 μm to about 15 μm, from about 1 μm to about 12 μm, from about 1 μm to about 10 μm, from about 1 μm to about 5 μm, from about 1 μm to about 3 μm, for example, about 2 μm.

I-A-1-b. Wash Coat and/or Metallized Coating

Optionally, the outer surface of the top layer of each biodegradable film of the pouch contains a release wash coat (see, e.g., FIG. 16, 17′) for enhanced jaw release properties of the top layer. The release wash coat facilitates the release of the film from a seal bar during the manufacturing process to produce the pouch. For example, as shown in FIG. 16, a wash coat 17′ is on top of the first/top moisture barrier heat-seal coating 11′.

The top layer is preferably transparent. However, in some forms, a metallic coating or light-blocking material is coated on the outer surface of the top layer. For example, although not shown in FIG. 16, in place of a wash coat 17′, a metallic coating can be on top of the first/top moisture barrier heat-seal coating 11′. When both a wash coat and a metallic coating are present in the top layer, the metallic coating can be disposed on top of the wash coat 17′. In some forms, the metallic coating is directly disposed on the top 121′ and/or bottom 122′ surfaces of the cellophane 12′. In these forms, a moisture barrier heat-seal coating is optionally on top of the top metallic coating.

The top layer may be formed by cellophane and optionally one or more moisture barrier layers using any suitable methods known in the art, or is provided as a commercially available material, such as NatureFlex™ NKR.

### I-A-2. Seal Layer

Generally, the seal layer of each biodegradable film forms the innermost layer of the biodegradable pouch. As such, the seal layers of the front and back biodegradable films form the wall of the internal compartment. The inner surface of each seal layer (i.e., the surface facing the internal compartment) is exposed to the internal compartment.

In some forms, the inner surfaces of the seal layers are in direct contact with the pharmaceutical formulation enclosed therein. For example, the pharmaceutical formulation is a liquid vaccine, and the inner surfaces of the seal layers are in contact with the liquid vaccine. For example, the pharmaceutical formulation is a soft chew, and at least a portion of the inner surfaces of the seal layers are in contact with the soft chew.

The seal layer contains polybutylene succinate adipate (“PBSA”), polybutylene adipate terephthalate (“PBAT”), a copolymer of PBSA and PBAT, or a mixture of PBSA and PBAT. In some forms, the seal layer is formed by PBSA. The PBSA and/or PBAT forming the seal layer is food contact grade and thus is compatible with the pharmaceutical formulation, such as an oral recombinant rabies vaccine. Further, the PBSA and/or PBAT do not absorb water. Accordingly, seal layer formed by PBSA and/or PBAT can prevent swelling of the pouch and thereby prevent leakage of the pharmaceutical formulation, in particular liquid pharmaceutical formulation enclosed therein. When the seal layer is or contains PBSA, it is heat sealable and can be used to join the front composite material and back composite material to form the pouch.

The seal layer of each biodegradable film can have any suitable thickness, depending on the specific pharmaceutical formulations being packaged, storage conditions, distribution site and conditions, target animals, etc. In some forms, the seal layer can have a thickness ranging from about 20 μm to about 100 μm, from about 20 μm to about 80 μm, from about 30 μm to about 100 μm, from about 30 μm to about 80 μm, from about 50 μm to about 100 μm, from about 50 μm to about 80 μm, such as about 60 μm.

### I-A-3. Adhesive Layer

The adhesive layer of each biodegradable film is between and in contact with each of the top layer and seal layer. The adhesive layer is typically formed by an aqueous-based adhesive, such as a polyurethane adhesive dispersion. The aqueous-based adhesive is typically soil compostable in an environment, such as in a wild land or a neighborhood.

In some forms, the adhesive layer is formed by a polyurethane adhesive dispersion. Examples of polyurethane adhesive dispersion suitable for forming the adhesive layer are those described in US 2023/0092087 A1 and U.S. Pat. No. 8,956,497 B2. The polyurethane adhesive dispersion can be prepared according to US 2023/0092087 A1 and U.S. Pat. No. 8,956,497 B2, or is commercially available, such as Epotal® by BASF.

### I-A-4. Outer Coating

Optionally, the biodegradable pouch contains an outer coating for attracting wild animals, such as a coating of a bait material, a light-reflecting material, a scented material, or a combination thereof. When an outer coating is present, it is on the outer surface of the outermost layer of the biodegradable pouch, such as on the outer surface of the top layer.

In some forms, the outer coating of the biodegradable pouch contains a bait material, such as fruit, vegetables, nut butter (e.g., peanut butter), marshmallow, bacon, cat food, fish, or birdseed, or a combination thereof.

For example, the outer coating of the biodegradable pouch contains fish meal or is formed by fish meal.

### I-B. Pharmaceutical Formulation

The biodegradable pouch encloses a pharmaceutical formulation in the internal compartment. The biodegradable pouches are compatible with the pharmaceutical formulation and have sufficient barrier properties to protect the pharmaceutical formulations contained therein.

The pharmaceutical formulation can be in any suitable form, as long as it can be enclosed in the pouch. In some forms, the pharmaceutical formulation enclosed in the biodegradable pouch is in the form of a solid, such as a soft chew. In some embodiments, the pouch may include a soft chew, such as Ora Vet®, NexGuard®, or HeartGard®. In some forms, the pharmaceutical formulation enclosed in the biodegradable pouch is in the form of a liquid, such as a liquid vaccine, for example, a liquid rabies vaccine.

### I-B-1. Liquid Vaccine

The pharmaceutical formulation enclosed in the biodegradable pouch may be a liquid vaccine. Examples of liquid vaccine enclosed in the pouch include, but are not limited to, those for vaccinating wild animals, such as rabies vaccine, Recombitek® Oral Bordetella vaccine, Enterisol® Iletis vaccine for Salmonella, and Enterisol® vaccine for Salmonella.

I-B-1-a. Rabies Vaccine

In some forms, the biodegradable pouch encloses a rabies vaccine in the internal compartment for oral administration to wildlife. The oral rabies vaccine enclosed in the pouch may be formulated using ingredients known in the art, such as those described below, or is available as a commercial product, such as RABORAL V-RG®. For example, the biodegradable pouch encloses RABORAL V-RG® in the internal compartment for oral administration to wildlife.

In some forms, the pouch contains the rabies vaccine in the form of a viscous aqueous solution. The viscous aqueous solution can contain an effective amount of vectors that expresses one or more proteins of rabies glycoprotein or a fragment thereof under appropriate circumstances, and a suitable veterinary or pharmaceutically acceptable vehicle, excipient, or diluent including, but not limited to, sterile water, physiological saline, glucose, buffer and the like. The vehicle, excipient, or diluent may also include polyols, glaucids, and/or pH buffering agents. The vehicle, excipient, or diluent may, for example, also include amino acids, peptides, antioxidants, bactericide, and bacteriostatic compounds.

In some forms, the oral rabies vaccine enclosed in the pouch also contains non-ionic hydrophilic surfactants having a high hydrophilic-lipophilic balance (HLB) value. Exemplary non-ionic hydrophilic surfactants include ethoxylated fatty acid monoesters of sorbitan such as 20 ethoxyl groups, e.g., ethoxylated sorbitan monolaurate e.g., TWEEN 20®, ethoxylated sorbitan monopalmitate e.g., TWEEN 40®, ethoxylated sorbitan monostearate e.g., TWEEN 60®, ethoxylated sorbitan monooleate e.g., TWEEN 80®; ethoxylated fatty alcohols such as 15-30 ethoxyl groups such as BRIJ 78®, BRIJ 98®, BRIJ 721®; ethoxylated fatty acids such as 15-30 ethoxyl groups, e.g., MYRJ 49®, MYRJ 51®, MYRJ 52®, MYRJ 53®; non-ionic block-copolymers such as polyoxyethylene/polyoxypropylene copolymer (POE-POP) e.g., LUTROL F127®, LUTROL F68®, and combinations thereof.

In some forms, the oral rabies vaccine enclosed in the pouch may contain fatty acid esters of sorbitan (e.g. sorbitan monolaurate, like SPAN 20®, sorbitan monopalmitate, such as SPAN 40®, sorbitan monostearate, such as SPAN 60®, sorbitan tristearate, such as SPAN 65®, sorbitan monooleate, like SPAN 80®, sorbitan trioleate, like SPAN 85®, sorbitan monoisostearate, such as ARLACEL 987®, sorbitan isostearate, such as CRILL 6®), fatty acid esters of mannide (e.g. MONTANIDE 80®, mannide monooleate (such as ARLACEL A®), mannide dioleate, mannide trioleate, mannide tetraoleate), ethoxylated fatty acid esters of mannide (2, 3 or 4 ethoxyl groups) (e.g. MONTANIDE 888®, MONTANIDE 103®, ethoxylated mannide monooleate, ethoxylated mannide dioleate, ethoxylated mannide trioleate, ethoxylated mannide tetraoleate), and combinations thereof. The fatty acid may be oleate, palmitate, stearate, isostearate, laurate and combinations thereof.

In some forms, the oral rabies vaccine enclosed in the pouch may include mineral oils, such as paraffin oil including isoparaffinic oil and/or naphtenic oil, squalane, pristane, polyisobutene oil, hydrogenated polyisobutene oil, polydecene oil, polyisoprene oil, polyisopropene oil and the like. Such oils may, for example, be those marketed under the name “MARCOL 52®” or “MARCOL 82®” (produced by Esso, France) or “DRAKEOL 6VR®” or “DRAKEOL 5®” “DRAKEOL 7®” (produced by Penreco, USA), “CLEAROL®” (produced by Sonneborn, USA), “Paraffin Oil Codex AAB2®” (produced by Aiglon, France), BLANDOL (produced by Sonneborn, USA), ONDINA 915 (produced by Shell, UK). The oil may also be a mixture of oils comprising at least 2 oils selected among the oils described herein, and in any proportion. The mixture of oils may also contain at least one oil selected among the oils described above and at least one vegetable oil, and this vegetable oil represents from about 0.1% to about 33% of the oily phase, preferably from about 10% to about 25% v/v. These vegetable oils are unsaturated oils rich in oleic acid that are biodegradable and preferably liquid at the storage temperature (about +4° C.) or at least make it possible to give emulsions that are liquid at this temperature. For example, the vegetable oil may be groundnut oil, nut oil, sunflower oil, safflower oil, soya oil, onager oil and the like.

I-B-1-b. Properties

The liquid vaccine is protected by the biodegradable films of the pouch, such that the properties of the vaccine are maintained over an extended period of time at an elevated temperature (e.g., a temperature ≥24° C., at 1 atm) or at a low temperature (e.g., about 5° C., at 1 atm).

The properties of the vaccine in the biodegradable pouch can be evaluated by weight loss, osmolality, pH, and/or viral titers, following storage for a period of time at a set temperature, such as 5° C. or 30° C., at 1 atm.

For example, the weight loss of the biodegradable pouch enclosing the liquid vaccine is less than 15%, less than 12%, or less than 8%, following storage for at least 7 days, at least 14 days, or at least 21 days, at about 30° C. and 1 atm; or following storage for at least 1 month, at least 3 months, at least 6 months, at least 9 months, at least 12 months, at least 18 months, or at least 24 months, at about 5° C. and 1 atm.

For example, pH value and/or VRG titer of the liquid vaccine enclosed in the pouch has a change of less than 1, less than 0.9, less than 0.8, less than 0.7, less than 0.6, less than 0.5, less than 0.4, less than 0.3, less than 0.2, or less than 0.1, following storage for at least 7 days, at least 14 days, or at least 21 days, at about 30° C. and 1 atm; or following storage for at least 1 month, at least 3 months, at least 6 months, at least 9 months, at least 12 months, at least 18 months, or at least 24 months, at about 5° C. and 1 atm.

For example, liquid vaccine enclosed in the pouch has an osmolality of less than 600 mOsm/kg, less than 550 mOsm/kg, less than 500 mOsm/kg, less than 450 mOsm/kg, less than 400 mOsm/kg, less than 350 mOsm/kg, or less than 300 mOsm/kg, following storage for at least 7 days, at least 14 days, or at least 21 days, at about 30° C. and 1 atm; or following storage for at least 1 month, at least 3 months, at least 6 months, at least 9 months, at least 12 months, at least 18 months, or at least 24 months, at about 5° C. and 1 atm.

In some forms, liquid vaccine enclosed in the pouch has a pH and/or a VRG titer that is similar to the pH and/or VRG titer of a control polyethylene packaging (see, e.g., Example 2), tested over an extended period of time at an elevated temperature (e.g., a temperature ≥24° C., at 1 atm) or at a low temperature (e.g., about 5° C., at 1 atm), such as using the method described in Example 2 below.

In some forms, liquid vaccine enclosed in the pouch has an osmolality that is similar to the osmolality of a control polyethylene packaging (see, e.g., Example 2), tested over an extended period of time at an elevated temperature (e.g., a temperature ≥24° C., at 1 atm) or at a low temperature (e.g., about 5° C., at 1 atm), such as using the method described in Example 2 below.

### I-B-2. Soft Chew

In some forms, the pharmaceutical formulation enclosed in the biodegradable pouch is in the form of a soft chew (also referred to herein as a “soft chewable formulation”). Examples of solid formulations enclosed in the pouch include, but are not limited to, soft chews for administration of veterinary medicine and dental hygiene chews for animals, such as Ora Vet®, NexGard® chews, and HeartGard® chews.

OraVet® is a dental hygiene chew which utilizes a dual-action formula that helps protect and clean an animal's teeth, e.g., a dog's teeth. OraVet® chews contain delmopinol, an ingredient used in human oral care rinses. Delmopinol coats the teeth, preventing bacteria from attaching to the enamel, inhibiting plaque formation, and keeping the animal's mouth protected. When an animal, such as a dog, bites into an OraVet® chew, the chewing action removes plaque on the teeth all the way down to the gumline. As this occurs, delmopinol is released and coats the teeth to help prevent bacterial attachment.

NexGard® is a beef-flavored chew for dogs and puppies from eight weeks of age that contains afoxolaner to kill fleas before they can lay eggs, ticks, and mites with monthly treatments. Heartgard Plus® is a soft chew for dogs that contains ivermectin/pyrantel to prevent canine heartworm disease by eliminating the tissue stage of heartworm larvae for a month (30 days) after infection, and to treat and control roundworms and hookworms.

I-B-2-a. Soft Chewable Formulations

Generally, the soft chewable formulation enclosed in the biodegradable pouch contains one or more active agents. The soft chewable formulations are palatable and convenient to administer to certain animals, e.g., raccoons and coyotes, and may be used effectively to dose veterinary medicine to these animals.

Any orally administrable active drug or other biologically active agent may be provided in the soft chewable formulation. The active agent can be an antiparasitic, antipruritic, antibiotics, analgesics, antivirals, antifungals, anthelmintics, endo- and ecto-parasticides, hormones and/or derivatives thereof, anti-inflammatoireluding non-steroidal anti-inflammatories), steroids, behavior modifiers, vaccines, antacids, laxatives, anticonvulsants, sedatives, tranquilizers, antitussives, antihistamines, decongestants, expectorants, appetite stimulants and suppressants, minerals, and vitamins. In some forms, the active agent contained in the soft chewable formulation is delmopinol.

The soft chews are typically manufactured by blending and extrusion, blending and knock-out, injection molds, and others. For extrusion, pre-mixed ingredients are introduced into an extruder barrel with a single or twin screw therein, then mixed, coagulated, expanded, and sheared into a blended mixture, followed by application of additional heat or water for proper extrusion. The blended and extruded mixture is then formed into a desired shape on a die plate and cut into individual units.

In some forms, the soft chewable formulation can include one or more binding agents e.g., a veterinary acceptable binding agent. Examples of acceptable veterinary binding agents that can be used include but are not limited to microcrystalline cellulose, hydroxypropyl cellulose, hydroxypropyl methyl cellulose, ethyl cellulose, polyvinylpyrrolidone (e.g., povidone (Kollidon 25, 30, and 90) and co-povidone (Kollidon VA 64), polyethylene glycol, acacia, tragacanth gum, gelatin, sucrose, lactose (e.g., hydrous, anhydrous, monohydrate), xylitol, sorbitol, maltitol, corn starch, potato starch, carnauba wax, alginate, and mixtures thereof.

In some forms, the soft chewable formulation can include one or more veterinary acceptable disintegrants. Examples of acceptable veterinary acceptable disintegrants include but are not limited to croscarmellose sodium, citric acid, and sodium starch glycolate, and mixtures thereof.

The soft chewable formulation optionally includes one or more anti-caking agents or lubricants to enhance the texture of the soft chewable formulation. Non-limiting examples of lubricants or anti-caking agents which may be used in the invention include magnesium stearate, calcium stearate, solid polyethylene glycols. For example, in some forms, magnesium stearate can be used for lubrication and as a component to aid in setting the edible soft chews after molding.

The soft chewable formulation optionally includes one or more humectants or wetting agents. In some forms, the wetting agent can be a hydrous or an anhydrous solvent. Examples of wetting agents include but are not limited to water, glycerin, propylene glycol, polyethylene glycol, ethanol, cetyl alcohol, glycerol monostearate, polysorbate 80, triacetin, and mixtures thereof. For example, glycerin is a clear, colorless, odorless, viscous, hygroscopic liquid, and is useful humectant in maintaining the softness of the edible soft chew over the shelf life of the product.

The soft chewable formulation optionally includes one or more softening agents. Softening agents limit density and hardness of the soft chew product. Such agents may include polysaccharides and fiber. Polysaccharides may be included in the form of a complex food such as a fruit, a plant starch such as potato or tapioca starch. Polysaccharide may also be provided separately, for example, in the form of chondroitin sulfate or glucosamine HCl. Fiber may be also provided as filler or as a bulking agent and to provide or maintain porosity in the edible soft chew. Fibers used to this end may be derived from fruits, grains, bran such as oat bran, legumes, vegetables, or seeds, or provided in forms such as wood fiber, paper fiber or cellulose fiber such as powdered cellulose fiber.

In some forms, the soft chewable formulation can include one or more veterinary acceptable flavoring agents such as an artificial flavoring agent or a natural flavoring agent. Examples of artificial flavoring agents include but are not limited to chicken, turkey, beef, pork, lamb, and fish. Non-limiting examples of natural flavoring agents include animal product-based flavorings such as uncooked dried meat parts such as beef, pork, chicken, turkey, fish and lamb; organ meats such as liver; meat meals, bone meals and ground bone; and animal-derived food such as casein, milk (which may include dry forms and lowered fat forms, such as dry skim milk), yogurt, gelatin, cheese and egg (collectively, “animal origin flavorings”) and mixtures thereof. Flavoring agents can also include vegetable matter and yeast extracts, for example brewer's yeast and hydrolyzed vegetable protein. Depending on the target animal, other non-animal flavorings could include anise oil, carob, peanuts, fruit flavors, sweeteners such as honey, sugar, maple syrup and fructose, herbs such as parsley, celery leaves, peppermint, spearmint, garlic, or combinations thereof.

The soft chewable formulation may contain one or more additional excipients, such as starches, cellulose, or derivatives or mixtures thereof, in amounts ranging, for example, from about 1 to about 60 percent (w/w), from about 2 to about 50 percent, or from about 15 to 50 percent. For example, the excipient may contain sodium starch glycolate, pregelatinized corn starch (Starch 1500), crospovidone (Polyplasdone XL™, International Specialty Products), and croscarmellose sodium (Ac-Di-Sol™, FMC Corp.), and derivatives thereof.

I-B-2-b. Properties

The soft chew is protected by the biodegradable films of the pouch, such that the properties of the soft chew are maintained over an extended period of time at an elevated temperature (e.g., a temperature ≥24° C., at 1 atm).

The properties of the soft chew in the biodegradable pouch can be evaluated by hardness, adhesiveness, cohesiveness, elasticity, gumminess, and/or chewability, following storage for a period of time at a set temperature, such as 24° C. or 40° C., at 1 atm.

For example, the hardness, adhesiveness, cohesiveness, elasticity, gumminess, and/or chewability of a soft chew enclosed in the biodegradable pouch is maintained (i.e., no statistical change), following storage for at least 1 months, at least 2 months, or at least 3 months, at about 24° C. or 40° C. and 1 atm.

In some forms, the hardness, adhesiveness, cohesiveness, and/or elasticity of a soft chew enclosed in the biodegradable pouch is similar (i.e., not statistically different) to the hardness, adhesiveness, cohesiveness, and/or elasticity of the original packaging of the soft chew, such as OraVet Original Packaging, tested using the method described in Example 5 below.

In some forms, the gumminess and/or chewability of a soft chew enclosed in the biodegradable pouch is similar (i.e., not statistically different) to the gumminess and/or chewability of the original packaging of the soft chew and/or the soft chew without any packaging, tested using the method described in Example 5 below.

### I-C. Properties of Biodegradable Pouch

Owing to the materials and structures of the biodegradable films, the biodegradable pouch formed therefrom is soil compostable, safe for animal's consumption, compatible with pharmaceutical formulations, and has sufficient barrier properties to protect the pharmaceutical formulations contained therein.

### I-C-1. Compostability

The biodegradable pouch is compostable. Compostable means that a product can disintegrate into non-toxic, natural elements, at a rate consistent with similar organic materials. Compostable products may be disintegrated in the presence of microorganisms, humidity, and/or heat to yield a finished compost product (CO₂, water, inorganic compounds, and biomass).

The biodegradable pouch can break down into carbon dioxide, water, and biomass at a similar rate as cellulose, disintegrating so that the remnants of the biodegradable pouch are substantially indistinguishable in a compost, i.e., is not readily visible and need not be screened out, and are not eco-toxic, i.e., degradation of the biodegradable pouch does not produce any toxic material and the compost can support soil health.

In some forms, the biodegradable pouch disintegrates into powder-like compost into soil under a standard test method for determining aerobic biodegradation of plastic materials in soil, such as ASTM D5988 conditions, up to 12 months at about 25° C. As demonstrated in non-limiting Example 2, the c-PBSA and m-PBSA sachets significantly mineralize and/or disintegrate more into the soil compared to the control sachets.

### I-C-2. Barrier Properties

The barrier properties of the biodegradable pouch can be evaluated by water vapor transmission rate (“WVTR”) and oxygen transmission rate (“OTR”).

Generally, the biodegradable pouch has a WVTR of less than 10 g/m² per day, less than 8 g/m² per day, or less than 5 g/m² per day, such as about 7 g/m² per day, measured at 38° C., 90% relative humidity; and/or an OTR of at least 10 cubic centimeters/square meter (cc/m²) per day, at least 12 cc/m² per day, at least 15 cc/m² per day, at least 20 cc/m² per day, at least 25 cc/m² per day, or at least 30 cc/m² per day, measured at 23.3° C., 0% relative humidity.

### II. Methods of Use

The biodegradable pouches are particular useful for administering pharmaceutical formulation to animals, especially wildlife, such as racoons, coyotes, grey foxes, dogs, cats, and cattle.

In some forms, the biodegradable pouches are used for vaccinating a wild animal, by distributing the biodegradable pouch disclosed herein in an environment, such as a forest or a neighborhood. In these forms, a bait material forms an outer coating of the biodegradable pouches, which can attract raccoons and other wildlife. When a raccoon or other wildlife finds the bait and bites into it, the sachet ruptures, allowing the pharmaceutical formulation, such as a liquid vaccine, to enter the animal's mouth. Raccoons and other wildlife then become vaccinated against rabies by this oral route.

The biodegradable pouches can be distributed using any suitable methods, such as distribution from airplanes flying at low altitude (e.g., about 500 feet). When distributed from airplanes, the biodegradable pouches are strong enough to withstand the impact when they touch the ground. The biodegradable pouches can be distributed based on wildlife population density. For example, the biodegradable pouches can be distributed at a density ranging from about 50 baits/km² to about 200 baits/km². In some forms, the biodegradable pouches are distributed at a density ranging from about 50 baits/km² to about 180 baits/km², from about 50 baits/km² to about 150 baits/km², from about 50 baits/km² to about 120 baits/km², from about 50 baits/km² to about 90 baits/km², or from about 50 baits/km² to about 70 baits/km² such as from about 75 baits/km² to about 150 baits/km².

### PARAGRAPHS

The disclosed compositions and methods can be further understood through the following enumerated paragraphs.
Paragraph 1. A biodegradable pouch for protecting a pharmaceutical formulation, including:
   (a) a front composite material and a back composite material,
   wherein the front and back composite materials are joined at a peripheral edge, forming an internal compartment,
   wherein each of the front and back composite materials comprises:
      (1) a top layer comprising cellophane;
      (2) an adhesive layer comprising polyurethane; and
      (3) a seal layer comprising polybutylene succinate adipate or polybutylene adipate terephthalate,
      wherein the adhesive layer is between and in contact with each of the top layer and seal layer, wherein the adhesive is an aqueous-based adhesive, and
   (b) the pharmaceutical formulation is in the internal compartment and is enclosed within the pouch.
Paragraph 2. The biodegradable pouch of paragraph 1, wherein the pharmaceutical formulation is in the form of a solid, optionally wherein the pharmaceutical formulation is a soft chew.
Paragraph 3. The biodegradable pouch of paragraph 1, wherein the pharmaceutical formulation is in the form of a liquid, optionally wherein the pharmaceutical formulation is a liquid vaccine.
Paragraph 4. A biodegradable pouch for protecting a liquid vaccine, including:
   (a) a front composite material and a back composite material,
   wherein the front and back composite materials are joined at a peripheral edge, forming an internal compartment,
   wherein each of the front and back composite materials comprises:
      (1) a top layer comprising cellophane;
      (2) an adhesive layer comprising polyurethane; and
      (3) a seal layer comprising polybutylene succinate adipate or polybutylene adipate terephthalate,
      wherein the adhesive layer is between and in contact with each of the top layer and seal layer, wherein the adhesive is an aqueous-based adhesive, and
   (b) the liquid vaccine is in the internal compartment and is enclosed within the pouch.
Paragraph 5. The biodegradable pouch of any one of paragraphs 1-5, wherein the top layer is a composite further comprising a top moisture barrier heat-seal coating on top of the cellophane, and optionally a bottom moisture barrier heat-seal coating on the bottom of the cellophane.
Paragraph 6. The biodegradable pouch of paragraph 5, wherein the top layer further comprises a metalized coating, wherein the metalized coating is on top of the top moisture barrier heat-seal coating.
Paragraph 7. The biodegradable pouch of any one of paragraphs 1-6, further comprising an outer coating comprising a bait material, such as bait made from a fruit, a vegetable, a nut butter (e.g., peanut butter), marshmallow, bacon, cat food, fish, or birdseed, or a combination thereof.
Paragraph 8. The biodegradable pouch of paragraph 7, wherein the outer coating comprises fish meal.
Paragraph 9. The biodegradable pouch of any one of paragraphs 1-8, wherein the top layer has a thickness ranging from about 10 μm to about 200 μm, from about 10 μm to about 150 μm, from about 10 μm to about 120 μm, from about 10 μm to about 100 μm, from about 10 μm to about 50 μm, from about 10 μm to about 30 μm, such as about 20 μm.
Paragraph 10. The biodegradable pouch of any one of paragraphs 1-9, wherein the seal layer has a thickness ranging from about 20 μm to about 100 μm, from about 20 μm to about 80 μm, from about 30 μm to about 100 μm, from about 30 μm to about 80 μm, from about 50 μm to about 100 μm, from about 50 μm to about 80 μm, such as about 60 μm.
Paragraph 11. The biodegradable pouch of any one of paragraphs 1-10, having
   a water vapor transmission rate (“WVTR”) of less than 10 g/m² per day, less than 8 g/m² per day, or less than 5 g/m² per day, such as about 7 g/m² per day, measured at 38° C., 90% relative humidity; and/or
   an oxygen transmission rate (“OTR”) of at least 10 cc/m² per day, at least 12 cc/m² per day, at least 15 cc/m² per day, at least 20 cc/m² per day, at least 25 cc/m² per day, or at least 30 cc/m² per day, measured at 23.3° C., 0% relative humidity.
Paragraph 12. The biodegradable pouch of any one of paragraphs 3-11, wherein the pharmaceutical formulation is a liquid rabies vaccine.
Paragraph 13. The biodegradable pouch of any one of paragraphs 1-12, wherein the weight loss of the biodegradable pouch is less than 15%, less than 12%, or less than 8%,
   following storage for at least 7 days, at least 14 days, or at least 21 days, at about 30° C. and 1 atm; or
   following storage for at least 1 month, at least 3 months, at least 6 months, at least 9 months, at least 12 months, at least 18 months, or at least 24 months, at about 5° C. and 1 atm.
Paragraph 14. The biodegradable pouch of any one of paragraphs 3-13, wherein the pH value and/or VRG titer of the liquid vaccine has a change of less than 1, less than 0.9, less than 0.8, less than 0.7, less than 0.6, less than 0.5, less than 0.4, less than 0.3, less than 0.2, or less than 0.1,
   following storage for at least 7 days, at least 14 days, or at least 21 days, at about 30° C. and 1 atm; or
   following storage for at least 1 month, at least 3 months, at least 6 months, at least 9 months, at least 12 months, at least 18 months, or at least 24 months, at about 5° C. and 1 atm.
Paragraph 15. The biodegradable pouch of any one of paragraphs 3-15, wherein the liquid vaccine has an osmolality of less than 600 mOsm/kg, less than 550 mOsm/kg, less than 500 mOsm/kg, less than 450 mOsm/kg, less than 400 mOsm/kg, less than 350 mOsm/kg, or less than 300 mOsm/kg,
   following storage for at least 7 days, at least 14 days, or at least 21 days, at about 30° C. and 1 atm; or
   following storage for at least 1 month, at least 3 months, at least 6 months, at least 9 months, at least 12 months, at least 18 months, or at least 24 months, at about 5° C. and 1 atm.
Paragraph 16. A method for vaccinating a wild animal, including:
   distributing the biodegradable pouch of any one of paragraphs 1-15 in an environment.
Paragraph 17. The method of paragraph 16, wherein the biodegradable pouches are distributed at a density ranging from about 50 baits/km² to about 200 baits/km²
Paragraph 18. The method of paragraph 16 or 17, wherein the wild animal is a racoon.
Paragraph 19. The method of any one of paragraph 16-18, wherein the biodegradable pouch is distributed in a forest or a neighborhood.

### EMBODIMENTS

The disclosed compositions and methods can be further understood through the following enumerated embodiments.
Embodiment 1. A biodegradable pouch for protecting a pharmaceutical formulation, comprising:
   (a) a front composite material and a back composite material, wherein the front and back composite materials are joined at a peripheral edge, forming an internal compartment, wherein each of the front and back composite materials comprises: (1) a top layer; (2) an adhesive layer; and (3) a seal layer, wherein the adhesive layer is between and in contact with the corresponding top layer and seal layer, wherein the adhesive is an aqueous-based adhesive, and
   (b) the pharmaceutical formulation located in the internal compartment and enclosed within the pouch.
Embodiment 2. The biodegradable pouch of embodiment 1, wherein the pharmaceutical formulation is in the form of a solid, optionally wherein the pharmaceutical formulation is a soft chew.
Embodiment 3. The biodegradable pouch of embodiment 1, wherein the pharmaceutical formulation is in the form of a liquid, optionally wherein the pharmaceutical formulation is a liquid vaccine.
Embodiment 4. A biodegradable pouch for protecting a liquid vaccine, comprising:
   (a) a front composite material and a back composite material, wherein the front and back composite materials are joined at a peripheral edge, forming an internal compartment, wherein each of the front and back composite materials comprises: (1) a top layer; (2) an adhesive layer; and (3) a seal layer, wherein the adhesive layer is between and in contact with the corresponding top layer and seal layer, and wherein the adhesive is an aqueous-based adhesive, and
   (b) the liquid vaccine located in the internal compartment and enclosed within the pouch.
Embodiment 5. The biodegradable pouch of any one of embodiments 1 to 4, wherein the peripheral edge is located on an outer surface of each of the seal layers, such that the internal compartment is formed between the seal layers of the front and back composition materials.
Embodiment 6. The biodegradable pouch of any one of embodiments 1 to 5, wherein the top layer comprises, or substantially consists of, or consists of cellophane.
Embodiment 7. The biodegradable pouch of any one of embodiments 1 to 6, wherein the adhesive layer comprises, or substantially consists of, or consists of polyurethane.
Embodiment 8. The biodegradable pouch of any one of embodiments 1 to 7, wherein the seal layer comprises, or substantially consists of, or consists of polybutylene succinate adipate or polybutylene adipate terephthalate.
Embodiment 9. The biodegradable pouch of any one of embodiments 1 to 8, wherein the top layer is a composite further comprising a top moisture barrier heat-seal coating on top of the cellophane.
Embodiment 10. The biodegradable pouch of any one of embodiments 1 to 9, wherein the top layer is a composite further comprising a bottom moisture barrier heat-seal coating on the bottom of the cellophane.
Embodiment 11. The biodegradable pouch of any one of embodiments 1 to 10, wherein the top layer further comprises a metalized coating on top of the top moisture barrier heat-seal coating.
Embodiment 12. The biodegradable pouch of any one of embodiments 1 to 11, further comprising an outer coating comprising a bait material.
Embodiment 13. The biodegradable pouch of any one of embodiments 1 to 12, wherein the bait material comprises bait made from fruit, vegetable, nut butter (e.g., peanut butter), marshmallow, bacon, cat food, fish, or birdseed, or a combination thereof.
Embodiment 14. The biodegradable pouch of any one of embodiments 1 to 13, wherein the outer coating comprises fish meal.
Embodiment 15. The biodegradable pouch of any one of embodiments 1 to 14, wherein the top layer has a thickness ranging from about 10 μm to about 200 μm, from about 10 μm to about 150 μm, from about 10 μm to about 120 μm, from about 10 μm to about 100 μm, from about 10 μm to about 50 μm, or from about 10 μm to about 30 μm.
Embodiment 16. The biodegradable pouch of any one of embodiments 1 to 15, wherein the top layer has a thickness of about 20 μm.
Embodiment 17. The biodegradable pouch of any one of embodiments 1 to 16, wherein the seal layer has a thickness ranging from about 20 μm to about 100 μm, from about 20 μm to about 80 μm, from about 30 μm to about 100 μm, from about 30 μm to about 80 μm, from about 50 μm to about 100 μm, or from about 50 μm to about 80 μm.
Embodiment 18. The biodegradable pouch of any one of embodiments 1 to 17, where the seal layer has a thickness of about 60 μm.
Embodiment 19. The biodegradable pouch of any one of embodiments 1 to 18, having a water vapor transmission rate (“WVTR”) of less than 10 g/m² per day, less than 8 g/m² per day, or less than 5 g/m² per day, such as about 7 g/m² per day, measured at 38° C., 90% relative humidity.
Embodiment 20. The biodegradable pouch of any one of embodiments 1 to 19, having a WVTR of about 7 g/m² per day, measured at 38° C., 90% relative humidity.
Embodiment 21. The biodegradable pouch of any one of embodiments 1 to 20, having an oxygen transmission rate (“OTR”) of at least 10 cc/m² per day, at least 12 cc/m² per day, at least 15 cc/m² per day, at least 20 cc/m² per day, at least 25 cc/m² per day, or at least 30 cc/m² per day, measured at 23.3° C., 0% relative humidity.
Embodiment 22. The biodegradable pouch of any one of embodiments 1 to 21, wherein the pharmaceutical formulation is a liquid rabies vaccine.
Embodiment 23. The biodegradable pouch of any one of embodiments 1 to 22, wherein the weight loss of the biodegradable pouch is less than 15%, less than 12%, or less than 8%,
   following storage for at least 7 days, at least 14 days, or at least 21 days, at about 30° C. and 1 atm; or
   following storage for at least 1 month, at least 3 months, at least 6 months, at least 9 months, at least 12 months, at least 18 months, or at least 24 months, at about 5° C. and 1 atm.
Embodiment 24. The biodegradable pouch of any one of embodiments 1 to 23, wherein the pH value and/or VRG titer of the liquid vaccine has a change of less than 1, less than 0.9, less than 0.8, less than 0.7, less than 0.6, less than 0.5, less than 0.4, less than 0.3, less than 0.2, or less than 0.1,
   following storage for at least 7 days, at least 14 days, or at least 21 days, at about 30° C. and 1 atm; or
   following storage for at least 1 month, at least 3 months, at least 6 months, at least 9 months, at least 12 months, at least 18 months, or at least 24 months, at about 5° C. and 1 atm.
Embodiment 25. The biodegradable pouch of any one of embodiments 1 to 24, wherein the liquid vaccine has an osmolality of less than 600 mOsm/kg, less than 550 mOsm/kg, less than 500 mOsm/kg, less than 450 mOsm/kg, less than 400 mOsm/kg, less than 350 mOsm/kg, or less than 300 mOsm/kg,
   following storage for at least 7 days, at least 14 days, or at least 21 days, at about 30° C. and 1 atm; or
   following storage for at least 1 month, at least 3 months, at least 6 months, at least 9 months, at least 12 months, at least 18 months, or at least 24 months, at about 5° C. and 1 atm.
Embodiment 26. A method for vaccinating a wild animal, comprising distributing the biodegradable pouch of any one of embodiments 1 to 25 in an environment.
Embodiment 27. The method of embodiment 26, wherein the biodegradable pouches are distributed at a density ranging from about 50 baits/km² to about 200 baits/km².
Embodiment 28. The method of embodiment 26 or embodiment 27, wherein the wild animal is a racoon.
Embodiment 29. The method of any one of embodiments 26 to 28, wherein the biodegradable pouch is distributed in a forest or a neighborhood.

The present invention will be further understood by reference to the following non-limiting examples.

### EXAMPLES

### Example 1—Performance of Green Alternative Laminates for Raboral Sachets

### 1. Introduction

Two laminates were prepared and evaluated for barrier, mechanical, and end-of-life performance. The two materials were metallized Natureflex-Epotal-PBSA laminate films (m-PBSA) and non-metallized Natureflex-Epotal-PBSA laminate films (c-PBSA). Tensile testing, puncture testing, tear testing, WVTR, and OTR were tested for both laminate films. Results show that the m-PBSA and c-PBSA films are comparable for all mechanical properties and have a slight difference in the WVTR performance, which is to be expected based on material composition. Sachets were made from each film on the commercial sachet line at the BIAH manufacturing plant in Athens, GA. Sachets were tested for biodegradation performance and mass loss over two weeks. Mass loss results showed that the non-metallized sachet had better mass retention than the metallized film, despite the metallized film having a better WVTR value. This is most likely due to the ability to better form sachets with the clear, non-metallized films, resulting in fewer leakers from imperfect seal lines.

### 2. Materials and Methods

The laminated films were prepared using standard adhesive laminator. The individual monolayer films for the moisture barrier layer (Natureflex), and seal layer were purchased. The Natureflex film was passed through a series of rollers, and the adhesive was applied to the Natureflex layer of the film. The seal layer was placed on the top of the Natureflex layer and secured to it.

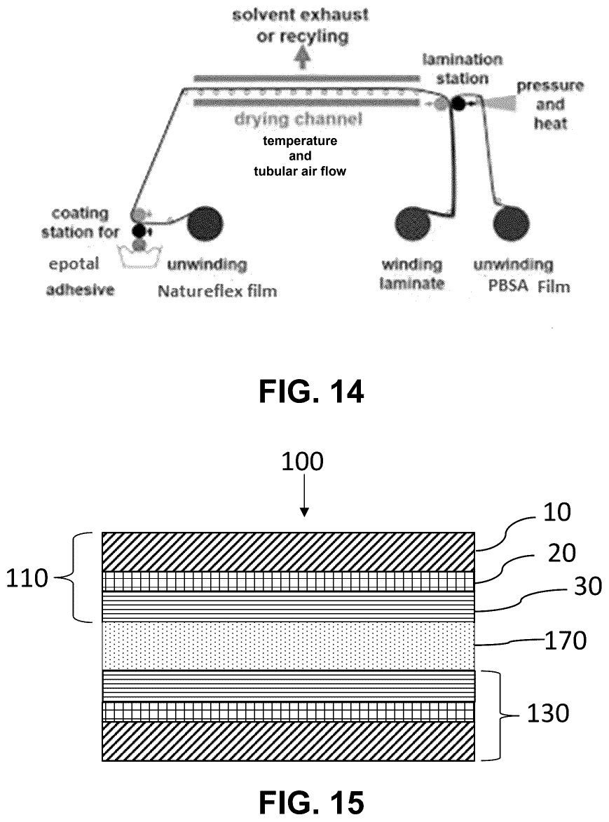

The sachets were manufactured on a Vertical Form Fill Seal (VFFS) machine, by adjusting the seal temperature, pressure, and cycles per min (cpm) based on the type of film used (FIG. 14). In some embodiments, the seal temperature is in a range of about 150-350 F. In some embodiments, the seal temperature is in a range of about 175-300 F. In some embodiments, the seal temperature is in a range of about 200-250 F. In some embodiments, the seal temperature is about 175 F, 200 F, 225 F, or 250 F. In some embodiments, the seal pressure is about 30-150 PSI. In some embodiments, the seal pressure is about 50-100 PSI. In some embodiments, the seal pressure is about 60 PSI, 70 PSI, or 80 PSI. In some embodiments, the sachets were made at about 15-60 cpm. In some embodiments, the sachets were made at about 20-40 cpm. In some embodiments, the sachets were made at about 30 cpm. For example, c-PBSA film sachets were manufactured at a seal temperature, seal pressure and cycle time of 200 F, 70 PSI and 30 cpm respectively, and the control sachets were manufactured at 250 F, 70 PSI and 30 cpm.

### 2.1. Materials

Raboral films were supplied by Boehringer Ingelheim and were tested without modification. m-PBSA and c-PBSA films were prepared and were tested without modification. The m-PBSA has a metallic coated cellophane top layer with a thickness of about 20 μm and a PBSA seal layer with a thickness of about 60 μm. The total thickness of the m-PBSA is about 90 μm. The c-PBSA has a cellophane top layer with a thickness of about 20 μm and a PBSA seal layer with a thickness of about 60 μm. The total thickness of the c-PBSA is about 90 μm.

### 2.2. Experimental Parameters and Procedures

### 2.2.1. WVTR

50 cm² films were cut from the film using the sample cutter. One sample per material was tested and the value reported. A Labthink Perme W3/230 water vapor transmission tester (Jinan, China) with ultrahigh purity nitrogen as the carrier gas was used for all testing. Tests were run at 38° C. and 90%±3% relative humidity in continuous mode. The sensor was purged for 1 hour before each test. Results were reported in g/m²-day. Sample thickness was measured using standard calipers and was taken on 6 different areas around the sample. The six measurements were averaged, and this value was used for sample thickness.

### 2.2.2. Oxygen Transmission Rate (OTR)

Oxygen Transmission Rate (OTR) testing was performed following the standard ASTM D3985-05. Films were cut to 50 cm² and masked when necessary for higher permeation or to facilitate mounting curled films in the diffusion cells. Tests were run at 23.3° C. and 0% relative humidity. Testing was conducted in duplicate (n=2). Results were reported in cc/m²-day.

### 2.2.3. Tensile Testing

Tensile testing was conducted using an Autograph AGS-X tensile tester fitted with a 1 Kilonewton (kN) load cell and TrapeziumX software by Shimadzu (Kyoto, Japan). ASTM Micro tensile test specimens were cut from film using a punch. Testing was conducted in triplicate (n=3) at a rate of 50 mm/min. The film thickness for each sample was measured using digital calipers and recorded in the TrapeziumX software for normalized result calculations.

### 2.2.4. Elmendorf Tear

Elmendorf tear testing was conducted using a LabThink 680 Elmendorf Tearing Tester equipped with proTear software (Boston, MA, USA). Testing was conducted using a standard Elmendorf Tear test shape with 200 gf of added pendulum weight in quadruplicate (n=4).

### 2.2.5. Puncture Testing

Puncture testing was conducted with a TA.XT plus 100 texture analyzer with Exponent Connect software (Godalming, Surrey, United Kingdom). The texture analyzer was outfitted with a puncture testing fixture (TA-108S-51) and a 2 mm cylindrical probe (TA-52) and analysis was conducted using the software's standard puncture testing method. Four puncture samples were collected (n=4).

### 2.2.6. Mass-Loss Testing

Mass loss tests were carried out by measuring the difference in mass of 2 ml distilled water heat sealed within a candidate film sachet over a 14-day period. Each sachet had a dimension of 1.3 by 4 inches in with a 1-inch outer seal. The seals were made using a SencorpWhite 12-AS/1 Pouch Sealer (Hyannis, MA, USA) at a temperature and pressure of 220° C. and 80 mTorr (MT) respectively. The weight of each sachet was recorded daily, and the mass loss was recorded as a percentage of the initial mass of the sachet (day 0). Three sachets were analyzed for each candidate film (n=3).

### 3. Results and Discussion

### 3.1. Barrier Performance

All laminates exhibit very low WVTR values, indicating their potential to provide an adequate barrier for the vaccine.

Moisture and oxygen transmission rates were tested for all films and the results are shown in Table 1. The WVTR results indicate that the metallized laminate offers better resistance to moisture transmission. However, all laminates have low WVTR values, indicating their potential to provide an adequate barrier for the vaccine. The WVTR data for the m-PBSA film (1.35 g/m²-day) was lower than that of c-PBSA (4.52 g/m²-day) This implies that m-PBSA film has better moisture barrier than the c-PBSA. However, the mass loss was higher for m-PBSA film than the c-PBSA film. It is hypothesized that the sachet forming with the clear, non-metallized laminates contributes to this effect. The increased transparency of the non-metallized films facilitates better alignment and formation on the sachet forming line, resulting in fewer “leakers” caused by imperfect cuts made during sachet formation. Given the better sachet forming and adequate WVTR, the non-metallized laminate is recommended as the first choice for an environmentally friendly sachet.

TABLE 1
Moisture and Oxygen Barrier Performance of the m-PBSA and c-PBSA Laminate Films Compared to the Control Raboral film.
n = 1 for WVTR, n = 2 for OTR, n = 3 for mass loss

| | | | Barrier Properties | | | | | |
|---|---|---|---|---|---|---|---|---|
| | | | WVTR | OTR | | | | |
| | | | (g/m² - day) | (cc/m² - day) | | | | |
| | | | tested at | tested at | | | | |
| | Handmade/ | Thickness | 38° C., 90% | 23.3° C., 0% | Sachet Mass Loss (%) (n = 3) | | | |
| Name | Machine made | (mm) | RH (n = 1) | RH (n = 2) | Day 1 | Day 3 | Day 7 | Day 14 |
| c-PBSA | handmade | 0.16 | 7.32 | 13.5786 | | | | |
| | PBSA film, | | | | | | | |
| | handmade | | | | | | | |
| | lamination | | | | | | | |
| c-PBSA | converter made | n/a | 7.56 | n/a | | | | |
| | PBSA film, | | | | | | | |
| | handmade | | | | | | | |
| | lamination | | | | | | | |
| Natureflex/epotal/PBAT | handmade | 0.18 | 7.16 | 43.5097 | | | | |
| | PBAT film, | | | | | | | |
| | handmade | | | | | | | |
| | lamination | | | | | | | |
| Natureflex/epotal/PBAT/TPS | handmade | 0.2 | not run due to | 2.1153 | | | | |
| blend | PBAT/TPS | | poor | | | | | |
| | film, handmade | | performance | | | | | |
| | lamination | | | | | | | |
| Natureflex/epotal/PHA | handmade | 0.17 | 5.55 | 1.62975 | | | | |
| | PHA film, | | | | | | | |
| | handmade | | | | | | | |
| | lamination | | | | | | | |
| Control Raboral Film | converter made -- | 0.07 | 2.72 | 2.7796 | 0.16% | 0.34% | 0.82% | 1.89% |
| m-PBSA | converter made | 0.056 | 0.21 | | | | | |
| | PBSA film, | | | | | | | |
| | machine | | | | | | | |
| | lamination | | | | | | | |
| m-PBSA | converter made | 0.086 | 1.35 | 0.6992 ± | 0.71% | 2.35% | 5.69% | 12.17% |
| | PBSA film, | | | 0.07 | | | | |
| | machine | | | | | | | |
| | lamination | | | | | | | |
| c-PBSA | converter made | 0.090 | 4.52 | 0.6819 ± | 0.27% | 1.26% | 3.51% | 6.51% |
| | PBSA film, | | | 0.003 | | | | |
| | machine | | | | | | | |
| | lamination | | | | | | | |

### 3.2. Mechanical Performance

Mechanical testing results indicate that the tear strength, puncture strength, and Young's Modulus of the three samples are comparable as shown in Table 2 and Table 3. The Strain at Break for the current Raboral film is higher than that of the two proposed replacement films, i.e., m-PBSA and c-PBSA, it is not necessary for this metric to match. The Strains at Break for the control, m-PBSA and c-PBSA are all relatively low, suggesting a tendency towards brittle-like fractures, resulting in similar end failures (Table 2). The yield strength and the maximum stress for both proposed replacements are significantly higher than that of the control film. This could require the animal to exert more effort to completely tear the sachet, potentially improving the sachet's retention time in the animal's mouth, thereby increasing the vaccine efficacy.

TABLE 2
Results of tensile testing for all three laminates.
N = 3 for tensile tests

| | | | Mechanical properties | | | | | | | |
|---|---|---|---|---|---|---|---|---|---|---|
| | | | Tensile Testing (n = 3) | | | | | | | |
| | | Thickness | Young's | Young's | Strain at | Strain at | Yield | Yield | Maximum | Maximum |
| | Handmade/ | of the | Modulus, | Modulus, | Break, | Break, | Strength, | Strength, | Stress, | Stress, |
| Name | machine made | Film (mm) | MD (GPa) | CD (GPa) | MD (%) | CD (%) | MD (MPa) | CD (MPa) | MD (MPa) | CD (MPa) |
| c-PBSA | handmade | 0.16 | 1.26 ± 0.08 | 0.95 ± 0.02 | 9.2 ± 0.9 | 9 ± 1.6 | 15.1 ± 1.2 | 12.4 ± 1.4 | 30.3 ± 1.7 | 23.2 ± 2.7 |
| | PBSA film, | | | | | | | | | |
| | handmade | | | | | | | | | |
| | lamination | | | | | | | | | |
| c-PBSA | converter made | n/a | 2.75 ± 0.06 | 1.58 ± 0.27 | 3.5 ± 2.4 | 3 ± 0.4 | 41.5 ± 3.5 | 26.7 ± 7.7 | 46.3 ± 16.9 | 29.4 ± 5.6 |
| | PBSA film, | | | | | | | | | |
| | handmade | | | | | | | | | |
| | lamination | | | | | | | | | |
| Natureflex/ | handmade | 0.18 | 0.69 ± 0.15 | n/a | 812 ± 50 | n/a | 7.9 ± 2.3 | n/a | 23.2 ± 1.4 | n/a |
| epotal/PBAT | PBAT film, | | | | | | | | | |
| | handmade | | | | | | | | | |
| | lamination | | | | | | | | | |
| Natureflex/ | handmade | 0.2 | 0.98 ± 0.27 | n/a | 18 ± 2 | n/a | 8.3 ± 0.8 | n/a | 18.3 ± 6.1 | n/a |
| epotal/PBAT/ | PBAT/TPS | | | | | | | | | |
| TPS blend | film, handmade | | | | | | | | | |
| | lamination | | | | | | | | | |
| Natureflex/ | handmade | 0.17 | 2.14 ± 0.39 | n/a | 4 ± 0.1 | n/a | 38.2 ± 18.1 | n/a | 45.6 ± 18.4 | n/a |
| epotal/PHA | PHA film, | | | | | | | | | |
| | handmade | | | | | | | | | |
| | lamination | | | | | | | | | |
| Control | converter made | 0.07 | 1.19 ± 0.05 | n/a | 26 ± 8 | n/a | 13.2 ± 2.2 | n/a | 20.6 ± 2.9 | n/a |
| Raboral | | | | | | | | | | |
| Film | | | | | | | | | | |
| m-PBSA | converter made | 0.056 | 1.9 ± 0.06 | | 15.7 ± 1.7 | | 16.5 ± 1.9 | | 54.5 ± 3.4 | |
| | PBSA film, | | | | | | | | | |
| | machine | | | | | | | | | |
| | lamination | | | | | | | | | |
| m-PBSA | converter made | 0.086 | 1.9 ± 0.2 | | 16.7 ± 0.7 | | 21.7 ± 4.3 | | 57.2 ± 3.2 | |
| | PBSA film, | | | | | | | | | |
| | machine | | | | | | | | | |
| | lamination | | | | | | | | | |
| c-PBSA | converter made | | 1.56 ± 0.2 | | 14.8 ± 0.7 | | 15.6 ± 1.7 | | 42.6 ± 1.2 | |
| | PBSA film, | | | | | | | | | |
| | machine | | | | | | | | | |
| | lamination | | | | | | | | | |

TABLE 3
Puncture Strength and Elmendorf Tear Strength for all laminates
(n = 4 for both Elmendorf and puncture testing)

| | Mechanical properties | | | |
|---|---|---|---|---|
| | Puncture testing (n = 4) | | | Elmendorf Tear |
| | Maximum | Work of Puncture | Strain at | Tear Force (gf/in) |
| Name | Force (N) | (N-mm) | Puncture | (n = 4) |
| c-PBSA (handmade) | 23.7 ± 2.0 | 22.5 ± 2.9 | 2.0 ± 0.3 | 117 ± 17 |
| c-PBSA (converter made PBSA film, | 23.4 ± 0.5 | 22.0 ± 1.4 | 2.0 ± 0.1 | 33 ± 1.4 |
| handmade lamination) | | | | |
| Natureflex/epotal/PBAT (handmade) | 23.2 ± 0.8 | 24.4 ± 1.3 | 2.4 ± 0.08 | 480 ± 88 |
| Natureflex/epotal/PBAT/TPS blend | 27.8 ± 0.9 | 26.0 ± 0.9 | 2.0 ± 0.03 | 155 ± 18 |
| (handmade) | | | | |
| Natureflex/epotal/PHA (handmade) | 32.5 ± 3.1 | 41.1 ± 8.2 | 2.4 ± 0.4 | 115 ± 28 |
| Control Raboral Film (converter made) | 16.0 ± 0.7 | 14.1 ± 1.2 | 1.93 ± 0.1 | 47 ± 3 |
| m-PBSA 56 μm (converter made film, | 17.8 ± 0.6 | 15.5 ± 0.4 | 1.9 ± 0.02 | 52.6 ± 10.6 |
| machine lamination) | | | | |
| m-PBSA 86 μm (converter made film, | 18.2 ± 0.3 | 16.6 ± 0.4 | 2.0 ± 0.03 | 50.3 ± 2.9 |
| machine lamination) | | | | |
| c-PBSA (converter made film, | 16.3 ± 0.8 | 14.2 ± 1.5 | 1.8 ± 0.1 | 45.8 ± 0.7 |
| machine lamination) | | | | |

TABLE 4
Data for Percentage Weight Change and pH for Storage at 5° C.

| | % Weight change = (T0 − Tx)/T0*100 | | | pH | | |
|---|---|---|---|---|---|---|
| Lot# | 0 Month | 1 Month | 3 Months | 0 Month | 1 Month | 3 Months |
| 3 8001 3 B021 | 0 | 1.97 | 4.21 | 7.65 | 7.758 | 8.045 |
| (m-PBSA sachet) | 0 | 1.26 | 2.42 | | | |
| | 0 | 2.49 | 5.35 | | | |
| 3 8001 3 C023 | 0 | 1.06 | 2.32 | 7.65 | 7.39 | 8.19 |
| (c-PBSA sachets) | 0 | 1.45 | 2.93 | | | |
| | 0 | 1.58 | 3.22 | | | |
| 3 8001 8 D025 | 0 | −0.04 | 0.08 | 7.65 | 7.559 | 8.124 |
| (Control) | 0 | 0.00 | 0.05 | | | |
| | 0 | 0.01 | 0.07 | | | |

TABLE 5
Data for Weight of Sachet and Osmolarity for Storage at 5° C.

| | Weight of sachet (gm) | | | Osmo (mOsm/kg) | | |
|---|---|---|---|---|---|---|
| | 0 | 1 | 3 | 0 | 1 | 3 |
| Lot# | Month | Month | Months | Month | Month | Months |
| 3 8001 3 B021 (m-PBSA | 1.33208 | 1.31 | 1.28 | 279 | 385 | 434 |
| sachet) | 1.28512 | 1.27 | 1.25 | 276 | 392 | 406 |
| | 1.33802 | 1.30 | 1.27 | | | |
| 3 8001 3 C023 (c-PBSA | 1.32353 | 1.31 | 1.29 | 279 | 417 | 414 |
| sachets) | 1.14739 | 1.13 | 1.11 | 276 | 395 | 407 |
| | 1.40677 | 1.38 | 1.36 | | | |
| 3 8001 8 D025 (Control) | 1.23058 | 1.23 | 1.23 | 279 | 365 | 377 |
| | 1.10966 | 1.11 | 1.11 | 276 | 365 | 364 |
| | 1.0688 | 1.07 | 1.07 | | | |

Sachets made of m-PBSA, c-PBSA film and control film were hand filled with ~1 ml of vaccinia vector vaccine under a laminar flow hood. The sachets were then sealed using a Toss sealer and the filled sachets were placed in a stability chamber set at 5° C. Sachets were periodically removed from the stability chamber and the weight of the sachets, the vaccine's pH, osmolarity were measured.

Similar results were observed when the stability chamber was set to 30° C.

### 4. Conclusions

All laminates show adequate mechanical integrity and are similar to one another. The two PBSA laminates provide greater yield strength and maximum stress, increasing their overall toughness, which could potentially extend the residence time of the sachet in the animal's mouth. Although the strain at break is higher for the control film, all strains are low enough to potentially result in brittle fractures, thus minimizing differences between the lots. The WVTR for all laminates are within a low range, with the metallized sachet having the lowest WVTR. However, the mass loss results directly contradict this, which is hypothesized to be due to the poor alignment on the sachet forming line caused by the non-transparent nature of the metallized films. For these reasons, the non-metallized laminate could be a primary candidate for an environmentally friendly replacement or alternative to the current Raboral film.

### Example 2: Viricidal Impact Assessment of Sachets Made with Alternate Biodegradable Films—Assessment of Stability Using Accelerated Stability Data

### 1. Introduction

The objective of this study was to determine the accelerated stability for rabies vectored vaccinia virus vaccine sachets stored at 30° C./65% RH (relative humidity) for up to 21 days.

Experimental serials were tested at T=0 and weekly for 3 weeks (21 days). Under the conditions of this study, the decrease in VRG titer observed for the experimental serials made using alternate biodegradable film sachets (−0.4 and −0.5 log₁₀ TCID₅₀/mL) was similar to albeit slightly less than that observed for the control experimental serial (−0.8 log₁₀ TCID₅₀/mL).

### 2. Materials and Methods

### 2.1. Serials

i. 3 8001 3 B022, made using m-PBSA instead of polyethylene sachet film material.
ii. 3 8001 3 C024, made using c-PBSA instead of polyethylene sachet film material.
iii. 3 8001 3 D026, control made using the current polyethylene sachet film material.

Sachets of the final product serials designated for stability testing were held in containers in controlled and monitored storage conditions at 30° C./65% RH throughout the duration of the study. The Potency was tested on the day that the samples were removed from 30° C./65% RH storage and delivered to the laboratory for testing. Test articles were stored at 5° C. until the testing could be performed.

A common bulk experimental vaccine was used for all three serials. T=0 testing was performed on the bulk material.

### 2.2. Methods

TABLE 6
List of Tests Performed.

| Test | Method | Specification |
|---|---|---|
| Potency - Vaccinia | 9 CFR 113.8, | ≥7.7 Log (10) TCID(50)/dose |
| Recombinant | 1901.R0 V.C. | |
| Glycoprotein | | |
| (VRG) Titer | | |
| Identity | 1901.R0 V.C.8. | Positive (IFA titer must be |
| | | within 0.5 Log(10) of CPE titer) |
| Mass | Gravimentric | Report only |
| pH | pH meter | Report only |
| Osmometry | Osmometer | Report only |

Potency-VRG titer is TCID₅₀ (50 tissue culture infectious dose) is an endpoint dilution assay used to measure the infectious virus titer of Vaccinia Rabies vaccine. This method involves infecting cultured cells within a microplate. The identity test was performed on the harvested virus to confirm the Vaccinia Recombinant Glycoprotein virus by performing Immunofluorescence assay (IFA) and comparing the results with Cytopathic effect (CPE). Other tests include weighing the sachets over time to measure mass loss, measuring the pH and osmolarity of the vaccine.

### 3. Results

The results for tests performed on the samples are shown below in Tables 7-9.

TABLE 7
Results for Serial 3 8001 3 B022 (metallized-
coated Natureflex sachets)

| | | T = 7 | T = 14 | T = 21 |
|---|---|---|---|---|
| Timepoint (Days) | T = 0 | days | days | days |
| Potency - VRG titer | 8.3 | 8.2 | 8.1 | 8.0 |
| (Log (10) | 8.4 | 8.4 | 8.5 | 7.8 |
| TCID (50)/dose) | 8.1 | 8.3 | 8.0 | 7.9 |
| Average VRG titer | 8.3 | 8.3 | 8.2 | 7.9 |
| Identity | 0.0 (pos- | 0.0 (pos- | 0.0 (pos- | 0.0 (pos- |
| | itive) | itive) | itive) | itive) |
| Mass (% weight change) | 0.00 | 3.12 | 6.05 | 5.41 |
| | 0.00 | 4.56 | 8.17 | 12.44 |
| | 0.00 | 3.35 | 6.26 | 16.18 |
| Average Mass | 0 | 3.68 | 6.83 | 11.34 |
| (% weight change) | | | | |
| pH | 7.65 | 7.88 | 8.01 | 7.92 |
| Osmometry | 279 | 431 | 457 | 560 |
| | 276 | 429 | 468 | 576 |
| Osmometry (Average) | 278 | 430 | 463 | 568 |

TABLE 8
Results for Serial 3 8001 3 C024 (clear-coated
Natureflex sachets or c-PBSA sachets)

| | | T = 7 | T = 14 | T = 21 |
|---|---|---|---|---|
| Timepoint (Days) | T = 0 | days | days | days |
| Potency - VRG titer | 8.3 | 8.5 | 8.4 | 7.9 |
| (Log (10) | 8.4 | 8.1 | 8.2 | 7.9 |
| TCID (50)/dose) | 8.1 | 8.4 | 8.2 | 7.7 |
| Average VRG Titer | 8.3 | 8.3 | 8.3 | 7.8 |
| Identity | 0.0 (pos- | 0.0 (pos- | 0.0 (pos- | 0.0 (pos- |
| | itive) | itive) | itive) | itive) |
| Mass (% weight change) | 0.00 | 3.09 | 6.12 | 12.45 |
| | 0.00 | 2.82 | 5.87 | 8.21 |
| | 0.00 | 2.86 | 5.84 | 1.16 |
| Average Mass | 2.92 | 5.94 | 7.27 | 2.92 |
| (% weight change) | | | | |
| pH | 7.65 | 7.68 | 7.74 | 7.88 |
| Osmometry | 279 | 371 | 382 | 460 |
| | 276 | 373 | 386 | 499 |
| Average Osmometry | 278 | 372 | 384 | 480 |

TABLE 9
Results for Serial 3 8001 3 D026 (control polyethylene sachets)

| | | T = 7 | T = 14 | T = 21 |
|---|---|---|---|---|
| Timepoint (Days) | T = 0 | days | days | days |
| Potency - VRG titer | 8.3 | 8.2 | 8.0 | 7.5 |
| (Log (10) | 8.4 | 8.3 | 8.2 | 7.4 |
| TCID(50)/dose) | 8.1 | 8.3 | 8.1 | 7.6 |
| Average VRG Titer | 8.3 | 8.3 | 8.1 | 7.5 |
| Identity | 0.0 (pos- | 0.0 (pos- | 0.0 (pos- | 0.0 (pos- |
| | itive) | itive) | itive) | itive) |
| Mass (% weight change) | 0.00 | 0.42 | 0.92 | 1.52 |
| | 0.00 | 0.41 | 0.86 | 1.41 |
| | 0.00 | 0.35 | 0.77 | 1.31 |
| Average Mass | 0 | 0.39 | 0.85 | 1.41 |
| (% weight change) | | | | |
| pH | 7.65 | 7.78 | 7.86 | 7.91 |
| Osmometry | 279 | 349 | 454 | 380 |
| | 276 | 345 | 458 | 385 |
| Average Osmometry | 278 | 347 | 456 | 383 |

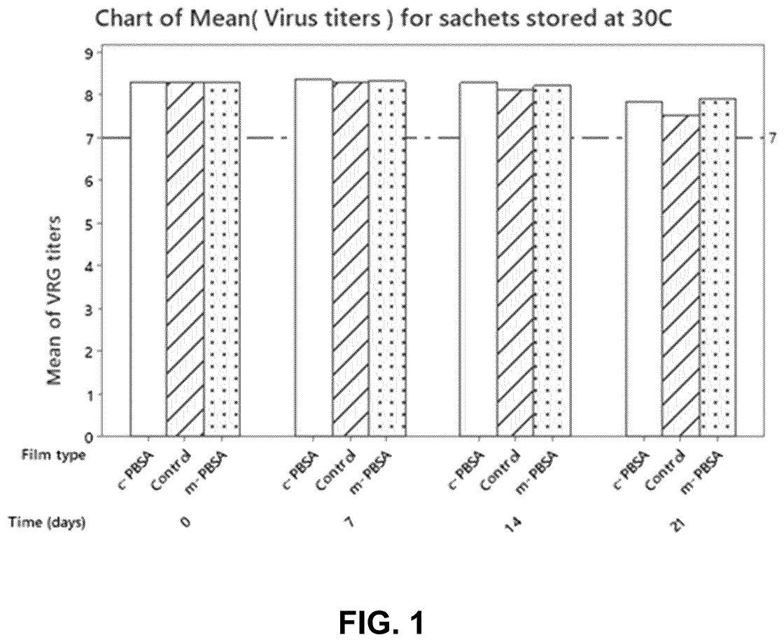

The statistical evaluation of the potency results demonstrates that the two experimental batches were more stable than the control study under the conditions evaluated (30° C./65% RH) over 21 days (FIG. 1).

TABLE 10
Weights for m-PBSA sachets, c-
PBSA sachets, and Control Sachets

| | Weight (gm) | | | |
|---|---|---|---|---|
| Lot Number | 0 | 7 days | 14 days | 21 days |
| 3 8001 3 B022 (m-PBSA sachet) | 1.27757 | 1.2377 | 1.20027 | 1.20847 |
| | 1.34716 | 1.28571 | 1.2371 | 1.17962 |
| | 1.26669 | 1.22421 | 1.18743 | 1.06176 |
| 3 8001 3 C024 (cPMSA sachets) | 1.32652 | 1.28557 | 1.24528 | 1.16136 |
| | 1.29036 | 1.25391 | 1.21463 | 1.18437 |
| | 1.16034 | 1.12717 | 1.09258 | 1.14689 |
| 3 8001 8 D026 (Control) | 1.24584 | 1.24061 | 1.23444 | 1.22694 |
| | 1.29899 | 1.29366 | 1.28783 | 1.28065 |
| | 1.16577 | 1.16174 | 1.15682 | 1.15051 |

### 4. Conclusion

The potency test results for the three test articles stored at 30° C./65% RH for 21 days are similar between the two experimental biodegradable sachet film serials and the experimental control serial. While the two experimental biodegradable sachet film serials demonstrated a greater mass loss than the control serial, the potency of the two experimental biodegradable sachet film serials was unaffected. This data suggests that the stability of the product made with metallized-coated Natureflex or clear-coated Natureflex as the sachet film material, rather than polyethylene, may be similar to the current polyethylene product.

### Example 3—Soily Aerobic Respirometry (25° C.) (Modified ASTM D5988-18)

### 1. Heavy Metal Analysis of Soil Inoculum Through University of Georgia (UGA) Soil Lab Via Total Acid Digestion

Experiments were conducted at 25° C. The inoculum was prepared as follows: 500 grams of soil sourced from three different locations (approximately 325 g total solids) at 30-40% water content was particle sieved with a 2 mm screen. The soil moisture holding capacity “MHC” was determined in accordance with ASTM D5988 Section § 11.4. The soil inoculum was tested for heavy metal content through total acid digestion (Table 11). All the heavy metals tested fell below maximum allowable range indicating good microbial health and activity. Test samples were cut into 1″×1″ size pieces and approximately 1.5 grams of each test sample were thoroughly integrated into the inoculum.

TABLE 11
Heavy Metal analysis of soil inoculum through UGA Soil Lab via total acid digestion
Total Acid Digestion
ppm (parts per million)

| Lab | Sample | Al | As | B | Ca | Cd | Cr | Cu | Fe | K | Mg |
|---|---|---|---|---|---|---|---|---|---|---|---|
| Values smaller than | | NL | <20 | NL | NL | <2 | <100 | <100 | NL | NL | NL |
| these pose minimal | | | | | | | | | | | |
| health risk | | | | | | | | | | | |
| 15059 | Compost | 6841 | 0.37 | 26.9 | 30950 | <0.010 | 11.3 | 29.4 | 7480 | 8892 | 4270 |
| | w/o samples | | | | | | | | | | |

| Lab | Sample | Mn | Mo | Na | Ni | P | Pb | S | Zn |
|---|---|---|---|---|---|---|---|---|---|
| Values smaller than | | <3500 | <440 | NL | <50 | NL | <75 | NL | <100 |
| these pose minimal | | | | | | | | | |
| health risk | | | | | | | | | |
| 15059 | Compost | 449 | 0.81 | 1754 | 5.57 | 5487 | 7.95 | 7307 | 164 |
| | w/o samples | | | | | | | | |

The soil mixture was 3.51% carbon and 0.30% nitrogen at the time of testing (C/N Ratio =11.7/1). The combustion method involves determination of organic carbon and nitrogen contents of the polymers with a Vario Elementar EL/max elemental analyzer using a Thermal Conductivity Detector (TCD) detector (Elementar Analysensysteme GmbH, Hanau, Germany).

The results in Table 11 show the amount of heavy metals in the soil inoculum prior to the start of the biodegradation study. It was determined that the pH of the soil inoculum was 6.70 at the beginning of testing, which is well within the 6.0-8.0 range for microbial health outlined by ASTM D5988-18.

### 2. Sample Moisture Content and Elemental Analysis

Each test sample and control group were analyzed for moisture content. A small aliquot of each material was massed, dried, and re-massed under desiccated conditions to determine the moisture content for each material (Table 11). This was performed on day-0 prior to testing to ensure accurate mass-ratios during reactor preparation.

TABLE 12
Moisture content of test materials and positive
control (Cellulose) for mass calculations, determined
with an infrared-drying balance on Day-0.

| Sample | Moisture (%) |
|---|---|
| Lot # SWST-164970005 | 4.97 |
| c-PBSA-0 70-2 Empty Sachets | 4.4 |
| m-PBSA-05352-11 Met. Cellophane | 3.6 |
| Cellulose | 3.7 |

Stable isotope ratio analysis performed by UGA CAIS-SIEL lab with an Elementar. Limit of detection is typically less than 0.10%. The results in Table 12 are estimated based on prior studies for early calculations.

TABLE 13
Carbon and Nitrogen Content of Test
Materials and Positive Control.

| Sample | Total C (%) | Total N (%) |
|---|---|---|
| Lot # SWST-164970005 | 61.46 | 0.6 |
| c-PBSA-0 70-2 Empty Sachets | 52.05 | 0.72 |
| m-PBSA-05352-11 Met. Cellophane | 52.22 | 0.9 |
| Cellulose | 42.29 | 0.13 |

* Percent carbon and nitrogen measurements include water mass in the measurement.

### 3. Respirometry Evaluation: Cumulative CO₂

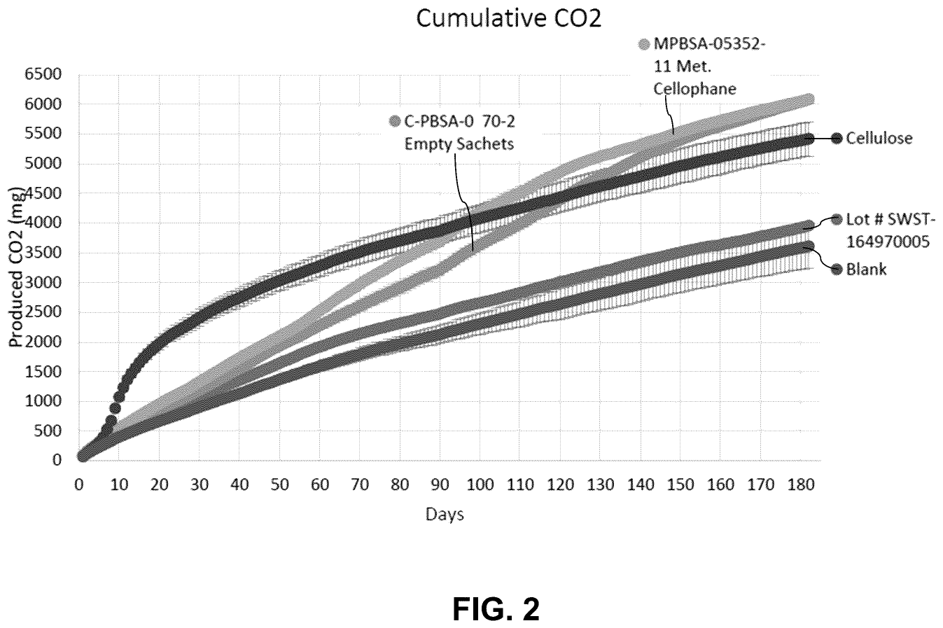

The cumulative CO₂ production curves were calculated by directly measuring the relative concentration of CO₂ in each individual reactor, taking into consideration the flowrate of each reactor's channel. Each test material i.e., c-PBSA and m-PBSA, and the control group represents an average of triplicate data points. A test material that either underperformed or matched the CO₂ production of the blank was not considered to be degrading in a manner quantitatively measurable with respirometry. The cumulative CO₂ data is shown in FIG. 2. The cumulative CO₂ graphs demonstrate that the c-PBSA and the m-PBSA replicate experiments produced on average 2,471 mg and 2,477 mg of CO₂ more than the blank control replicates, respectively. This indicates that the samples are responsible for the observed excess CO₂ production from the inoculum.

### 4. Respirometry Evaluation: Absolute Biodegradation

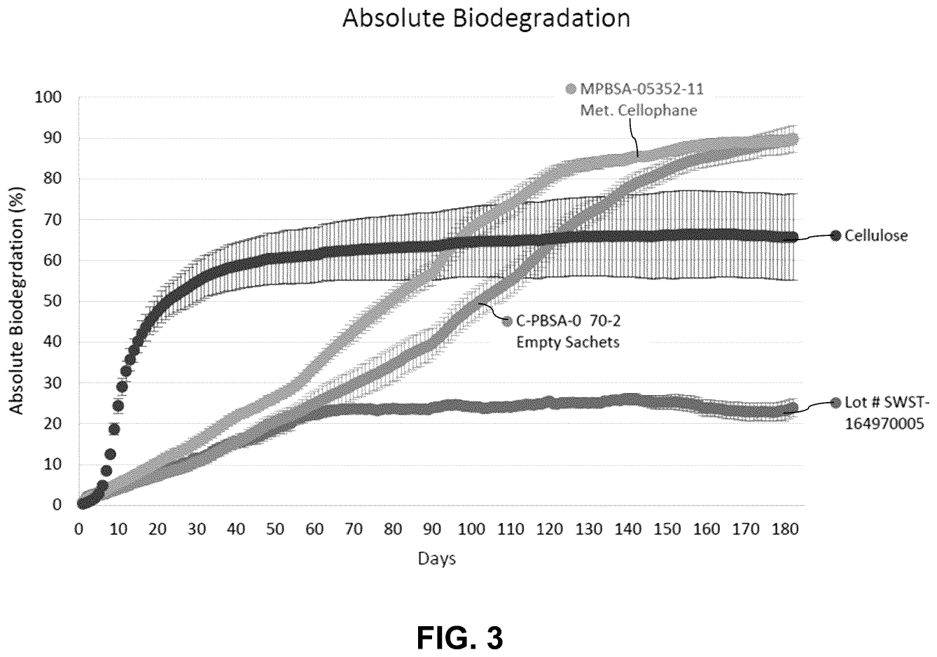

Absolute biodegradation values were determined from the percent of the theoretical mineralized carbon from each sample. Each test material i.e., c-PBSA and m-PBSA, and the control group represents an average of triplicate data points. All absolute biodegradation percentages were calculated using the comparative rate of the CO₂ production of the negative controls (blanks). The absolute biodegradation data is shown in FIG. 3. Absolute biodegradation calculations were done as described in ASTM D5988. Based on these calculations, it was found that approximately 90% of the organic carbon from both c-PBSA and m-PBSA samples mineralized in the first 182 days of testing.

### 5. Respirometry Evaluation: Relative Biodegradation

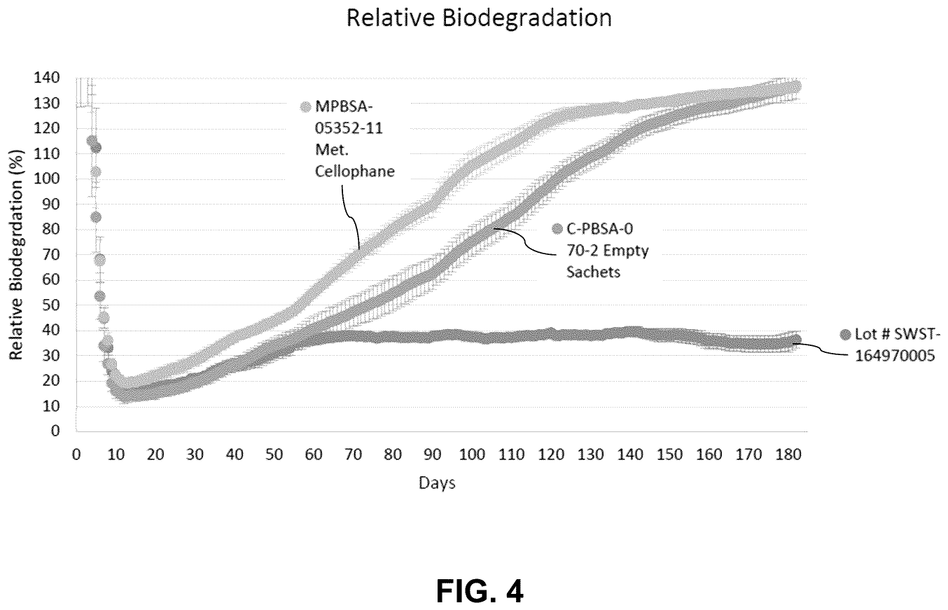

Biodegradation may also be evaluated by comparison with a positive control. In the beginning of the experiments, colonization of all samples and the positive control will vary significantly, which is shown by the variability in relative biodegradation values in the first week of testing (FIG. 4). Relative biodegradation values represent a comparison of the theoretical CO₂ generated from a sample compared to the CO₂ generated from the positive control (cellulose).

TABLE 14
182-day cumulative CO2 and percent biodegradation values.

| | | Day 182 | Day 182 | Day 182 |
|---|---|---|---|---|
| | Day 182 | Cumulative | Absolute | Relative |
| | Cumulative | CO₂ Standard | Biodegradation | Biodegradation |
| Sample | CO₂ (mg) | Deviation | (%) | (%) |
| Lot # SWST- | 3957.96 | 33.55 | 23.88 | 36.34 |
| 164970005 | | | | |
| m-PBSA-05352-11 | 6079.40 | 68.53 | 89.85 | 136.75 |
| Met. Cellophane | | | | |
| C-PBSA-0 70-2 | 6085.31 | 34.65 | 89.65 | 136.44 |
| Empty Sachets | | | | |
| Cellulose | 5415.84 | 290.85 | 65.71 | N/A |
| Blank | 3608.55 | 367.25 | N/A | N/A |

As shown in Table 14, the c-PBSA and the m-PBSA replicate experiments produced on average 2,471 mg and 2,477 mg of CO₂ more than the blank control replicates, respectively. Absolute biodegradation calculations were conducted as described in ASTM D5988. Approximately 90% of the organic carbon from both c-PBSA and m-PBSA samples mineralized in the first 182 days of testing. m-PBSA samples mineralized by 137% and c-PBSA samples mineralized by 136% relative to the cellulose control (Table 14).

Lot #SWST-164970005, m-PBSA, and c-PBSA samples were assessed, and photographs were taken. Photography from the biodegradation experiments revealed good disintegration of the two laminated biodegradable films i.e., c-PBSA and m-PBSA, compared to the control (sample fragments above 5 mm). It was observed that Lot #SWST-164970005 sample remained intact with no signs of degradation. The c-PBSA was almost fully degraded and the m-PBSA sample was completely degraded and fully integrated in the soil.

### 6. Discussion

By day 182 in the study, the positive control (cellulose) reached 65.71% carbon mineralization by absolute biodegradation calculations. The cellulose control produced about 34% less CO₂ than expected as determined by an absolute biodegradation of 65.71% by month 6. Notably, after 6 months of testing, both the metalized and control PBSA/cellophane structures were about 90% mineralized. All samples integrated uniformly into the soil on the first day of testing. Temperature variation was no more than +1° C. for either condition.

### Example 4—Evaluation of Novel Plastics as Oral Vaccine Containers in Raccoons

### 1. Introduction

The RABORAL V-RG® is a commercial oral vaccine-bait product with a record of safe and effective operational use for raccoons (Procyon lotor) and coyotes (Canis latrans) in the United States (Maki et al., 2017). RABORAL V-RG® is currently produced in two formats: fishmeal polymer (FMP) and coated sachet (CS). A sachet of the FMP is filled with ~1.5 mL of vaccine, sealed, and encased within a solid square fishmeal polymer block (23 g, 33 mm×33 mm×21 mm, Bait-Tek, Inc., Orange, Texas), containing an extruded mixture of fish meal and fish oil, with end use for hand-baiting and bait stations. The FMP bait matrix also contains 150 mg of tetracycline as a biomarker. The CS sachet is an opaque white polyethylene plastic sachet filled with ~1.5 mL of vaccine, sealed, and coated with wax, cod liver oil and fishmeal powder [9 g, 60 mm×20 mm×5 mm (Horman et al., 2012; Linhart et al., 2002)]. The CS baits do not contain any biomarker.

In recent years, there has been increasing recognition and documentation of the interactions of wildlife with plastic waste pollution (Ayala et al., 2023; Malizia and Monmany-Garzia, 2019), with negative impacts for animal health. The delivery of 8-10 million oral rabies vaccination (ORV) baits annually by the USDA APHIS Wildlife Services National Rabies Management Program is necessary to control and locally eliminate certain variants of wildlife rabies (Slate et al., 2009), yet the process of ORV may also potentially contribute to plastic waste pollution and can preclude approval for the use of ORV in certain protected natural areas. Alternative solutions to the current generation of ORV containers should be prioritized for research and development, in order to limit future impacts to biodiversity and ecosystems. The use of biodegradable materials in manufacturing ORV products is one possible alternative Bender et al. (2017)).

Refinements to the design of baits for RABORAL V-RG® were explored through earlier studies (QA2598), which included comparison of the CS (commercial reference sachet bait) with a reduced size CS and other improved test baits. The objective of the present study was to create an improved design of baits for RABORAL V-RG®. Two different CS formats manufactured using biodegradable plastics were tested and compared to the opaque white polyethylene plastic CS. Tests were performed for bait-uptake, animal interaction, and preference between the improved design of CS and the reference CS across two rounds of evaluation (i.e., one improved CS versus the reference CS during consecutive trials).

### 2. Methods

### 2.1. Animals and Housing.

Twenty raccoons (11 males and 9 females) were acquired by live trapping in Larimer County, Colorado, USA. Authorization for collection and holding was issued by Colorado Parks and Wildlife Scientific Collection License (23TR5321).

The raccoons were individually housed in the outdoor animal research facility at NWRC. Each enclosure was 3 m×3 m×2.5 m and contained a den box and enrichment structures. The raccoons were fed a maintenance diet (~200 g, Mazuri Ominvore-Zoo Feed “A”, Richmond, Indiana, USA) and enrichment food grade items (e.g., commercially available fruit, eggs, vegetables, popcorn, boiled meat). During the bait trials, enrichment food items were excluded, and their maintenance diet was evenly split between the bait offering and the evening (~8 hour) bait check. Water was available ad libitum throughout the study.

### 2.2. Baits

Boehringer Ingelheim Animal Health (BIAH) provided all the baits. The two improved baits (Bait B and Bait C) were compared in trials; each trial presented a choice between one improved bait (Bait B or Bait C), and one standard sachet bait (Bait A). Bait B had a metallic sheen while Bait C was a clear material. Bait A was a placebo version of the fishmeal CS used in oral rabies vaccination. As the standard sachet, it was ~6 cm×2 cm, filled with 1.5 mL of water, and coated with waxes, fishmeal crumbles, and cod liver oil. Bait B (metallic) and Bait C (clear) were similar in size to Bait A. All baits contained a similar amount of water and had the same coating as Bait A.

### 2.3. Bait Offering

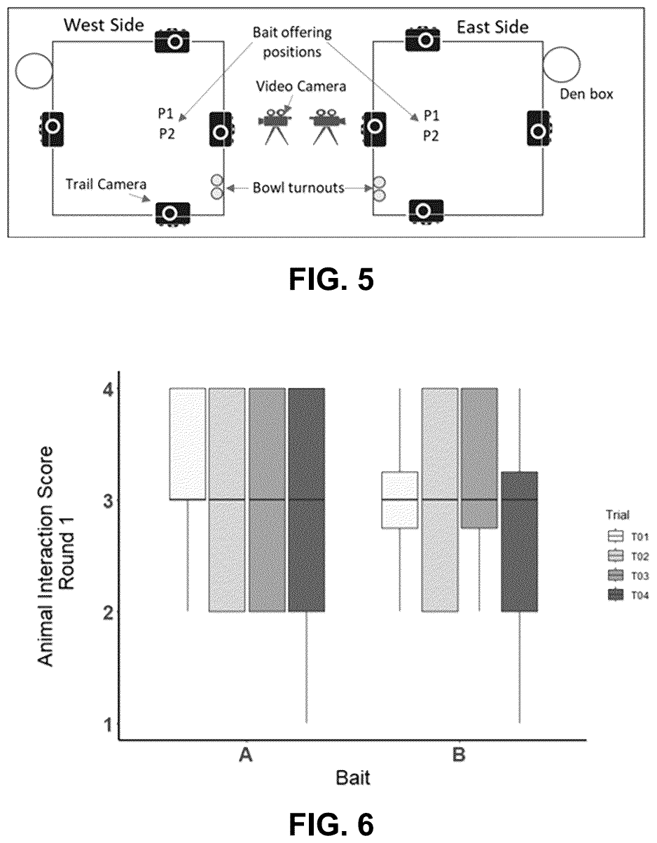

A single improved bait was compared to a single Bait A (standard CS) in consecutive trials. The baits were offered within the center front third on the floor of a raccoon's enclosure (P1 and P2 in FIG. 5). To familiarize the raccoons to the bait offering positions, enrichment food items were given at the bait offering location instead of in the raccoons' regular feed bowls for three days prior to the first trial. Four trials per round were conducted, using the same bait pair within a round, and altering baits between the two positions to account for approach biases. Round 1 included a comparison between Bait A vs Bait B. Round 2 included a comparison between Bait A vs Bait C.

A single trial was approximately 24-hours starting around 8:00 am with offering baits and half the maintenance diet and ending with the search and collection of any bait remains and maintenance diet. Bait checks and recording of the bait status occurred at approximately 4 hours, 8 hours and 24 hours after the bait offering. At the 8 hour check, the racoons were fed the remaining half of the maintenance diet. At the final check, the bait's condition was recorded capturing information on the approximate percentage remaining for the coating and the whole bait along with chewed and punctured status. Both baits and maintenance diet were weighed at the start and end of a trial.

Raccoons were randomly divided into two groups of 10. When group one received Bait A in position one, group two received Bait A in position two (FIG. 5).

### 2.4. Camera Set-Up and Scoring

Two types of camera systems were used to monitor uptake: a fixed video system (cameras: 2.0 W-H3-BO1-IR; software ACC 6 v6.14.20.2, Avigilon Corporation, Vancouver, British Columbia, Canada) and a trail camera system (HP2X, HyperFire 2 Professional Covert IR, Reconyx, Holmen, Wisconsin, USA). One camera was included per enclosure for the video system and four trail cameras per enclosure (FIG. 5). Data from all cameras were reviewed to determine order of approach and initial contact relative to the other bait. Review of the image data was spread out across two people with a third person conducting random and ad hoc check of the camera data review. For Round 2, image data were examined to detect spillage. Image data were combined with information from the last bait check to score animal-bait interactions (Table 15).

TABLE 15
The animal-interaction score and category for the different
behaviors observed and bait status recorded.

| Score | Category | Behaviors/Observations |
|---|---|---|
| 1 | No interaction | Animal does not come within 0.5 m of the bait |
| 2 | Interaction | Animal moves within 0.5 m of bait and rostrum |
| | | orients to the bait. No evidence of putting |
| | | the bait in its mouth. |
| 3 | Oral | Animal moves bait into its mouth or subsequent |
| | manipulation | inspection reveals changes in the bait |
| 4 | Full bait | No bait remains located |
| | consumption | |

### 2.5. Statistical Analysis

Summary statistics was prepared for the final bait check and the animal interaction score for each round. Graphs were prepared using the package ggolot [v. 3.4.4 (Wickham, 2016)] in R [v. 4.3.1, (R Core Team, 2023)]. The animal interaction score was analyzed using a cumulative link mixed model using the package ordinal (v. 2023.12.4) in R-package. The score was the response variable and bait was the predictor variable. The animal and trial were treated as random effects. The significance level was α≤0.05. To provide inference for a larger population, the 95% confidence interval (CI) was calculated for the percentages when either the total baits offered, or total raccoons was the denominator, using the VassarStats calculator (Lowry, 2023).

### 3. Results

### 3.1. Round 1

The raccoons received Bait A, the standard sachet, and Bait B, the metallic bait. Overall, the bait fates between Bait A and Bait B were similar (Table 16, Table 17).

TABLE 16
The fates of the baits from offering A and B baits to 20 raccoons in round
1. The round consisted of four trials each lasting approximately 24 hours.
One A bait and one B bait were offered to each raccoon in a single trial.
Unlocated baits were assumed to be completely consumed.

| | | Unlocated/ | Percent | Parts | Percent | | Percent |
|---|---|---|---|---|---|---|---|
| Bait | Offered | Consumed | (95% CI) | chewed | (95% CI) | Untouched | (95% CI) |
| A | 80 | 30 | 38 (27-48) | 28 | 35 (26-46) | 22 | 28 (19-38) |
| B | 80 | 23 | 29 (20-40) | 32 | 40 (30-51) | 25 | 31 (22-42) |
| Total | 160 | 53 | 33 (26-41) | 60 | 38 (30-45) | 47 | 29 (23-37) |

TABLE 17
The number of baits with evidence of chewing, separated by the approximate percentage
of the bait remaining, from offering A and B baits to 20 raccoons in round 1.

| | Parts | ~100% | | ~75% | | ~50% | | ~25% | |
|---|---|---|---|---|---|---|---|---|---|
| Bait | chewed | remaining | % | remaining | % | remaining | % | remaining | % |
| A | 28 | 2 | 7 | 4 | 14 | 4 | 14 | 18 | 61 |
| B | 32 | 2 | 6 | 1 | 3 | 8 | 25 | 21 | 66 |
| Total | 60 | 4 | 7 | 5 | 8 | 12 | 20 | 39 | 65 |

It was observed that 50% (10/20; CI 30-70%) and 65% (13/20; CI 43-82%) of the raccoons always had ≥25% of the Bait A and Bait B remaining, respectively (Table 18). One raccoon (5%, CI 1-24%) never took nor punctured Bait A and three raccoons (15%; CI 5-36%) never took nor punctured Bait B (Table 19).

TABLE 18
Number of raccoons associated with taking and consuming the bait
(i.e., bait not located) over the four trials in round 1. Each
raccoon was given a total of four A baits and four B baits.

| | | Number of baits assumed to be fully | | | | |
|---|---|---|---|---|---|---|
| | Total number | consumed by an individual raccoon | | | | |
| Bait | of raccoons | 4 | 3 | 2 | 1 | 0 |
| A | 20 | 5 | 2 | 1 | 2 | 10 |
| B | 20 | 2 | 5 | 0 | 0 | 13 |

TABLE 19
Number of raccoons associated with puncturing different numbers of the
baits over the four trials in round 1 based on raccoons with either
the A bait or B bait or parts of the baits located at the end of a
trial. Each raccoon was given a total of four A baits and four B baits.

| | | Number of baits identified as | | | | |
|---|---|---|---|---|---|---|
| | Total number | punctured by an individual raccoon | | | | |
| Bait | of raccoons | 4 | 3 | 2 | 1 | 0 |
| A | 15 | 2 | 1 | 5 | 6 | 1 |
| B | 18 | 4 | 1 | 1 | 9 | 3 |

Analysis of the animal interaction score indicated a trend for a higher interaction score and preference for Bait A, albeit without any statistical difference between Bait A and B (Table 20, FIG. 6).

TABLE 20
Cumulative link mixed model estimates for round 1 comparing Bait
A and Bait B using the animal interaction score. The model examined
the impact of Bait B on the animal interaction score compared to
Bait A. Higher estimates are associated with higher preference.

| Bait | Estimate | Standard Error | Z value | P |
|---|---|---|---|---|
| B | −0.80 | 0.42 | −1.89 | 0.059 |

### 3.2. Round 2

The raccoons received Bait A, the standard sachet, and Bait C, the clear bait. Overall, the bait fates between Bait A and Bait C were similar (Table 21, Table 22).

TABLE 21
The fates of the baits from offering Bait A and Bait C to 20 raccoons in
round 2. The round consisted of four trials each lasting approximately
24 hours. One Bait A and one Bait C were offered to each raccoon in a
single trial. Unlocated baits were assumed to be completely consumed.

| | | Unlocated/ | Percent | Parts | Percent | | Percent |
|---|---|---|---|---|---|---|---|
| Bait | Offered | Consumed | (95% CI) | chewed | (95% CI) | Untouched | (95% CI) |
| A | 80 | 33 | 41 (31-52) | 28 | 35 (25-46) | 19 | 24 (16-34) |
| C | 80 | 28 | 35 (25-46) | 34 | 43 (32-45) | 18 | 23 (20-39) |
| Total | 160 | 61 | 38 (31-46) | 62 | 39 (32-46) | 37 | 23 (17-30) |

TABLE 22
The number of baits with evidence of chewing, separated by the approximate percentage
of the bait remaining, from offering A and C baits to 20 raccoons in round 2.

| | Parts | ~100% | | ~75% | | ~50% | | ~25% | |
|---|---|---|---|---|---|---|---|---|---|
| Bait | chewed | remaining | % | remaining | % | remaining | % | remaining | % |
| A | 28 | 1 | 4 | 2 | 7 | 12 | 43 | 13 | 46 |
| C | 34 | 3 | 9 | 4 | 12 | 10 | 29 | 17 | 50 |
| Total | 62 | 4 | 7 | 6 | 10 | 22 | 36 | 30 | 48 |

It was observed that 35% (7/20; CI 18-57%) and 35% (7/20; CI 18-57%) of the raccoons always had ≥25% of the Bait A and Bait C remaining, respectively (Table 23). Three raccoons (15%, CI 5-36%) never took nor punctured Bait A and two raccoons (10%, CI 3-30%) never took nor punctured Bait C (Table 24).

TABLE 23
Number of raccoons associated with taking and consuming the bait
(i.e. bait not located) over the four trials in round 2. Each
raccoon was given a total of four A baits and four C baits.

| | | Number of baits assumed to be fully | | | | |
|---|---|---|---|---|---|---|
| | Total number | consumed by an individual raccoon | | | | |
| Bait | of raccoons | 4 | 3 | 2 | 1 | 0 |
| A | 20 | 6 | 1 | 1 | 5 | 7 |
| C | 20 | 4 | 1 | 2 | 6 | 7 |

TABLE 24
Number of raccoons associated with puncturing different numbers of the
baits over the four trials in round 1 based on raccoons with either
the Bait A or Bait C or parts of the baits located at the end of a
trial. Each raccoon was given a total of four A baits and four C baits.

| | | Number of baits identified as | | | | |
|---|---|---|---|---|---|---|
| | Total number | punctured by an individual raccoon | | | | |
| Bait | of raccoons | 4 | 3 | 2 | 1 | 0 |
| A | 14 | 3 | 3 | 2 | 3 | 3 |
| C | 16 | 0 | 6 | 5 | 3 | 2 |

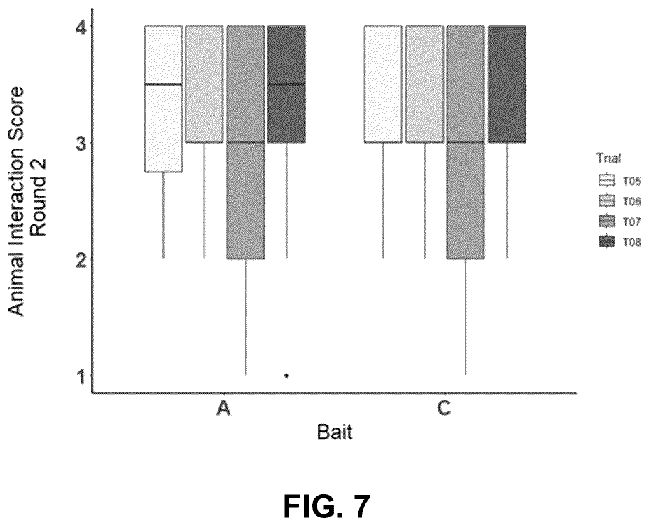

Analysis of the animal interaction score indicated a trend for a higher interaction score and preference for Bait A, albeit without any statistical difference between Bait A and C (Table 25, FIG. 7).

TABLE 25
Cumulative link mixed model estimates for round 1 comparing
Bait A and Bait C using the animal interaction score.
The reference was Bait A, the standard sachet. Higher
estimates are associated with higher preference.

| Bait | Estimate | Standard Error | Z value | P |
|---|---|---|---|---|
| B | −0.26 | 0.38 | −0.70 | 0.49 |

Spillage was reported for 34% (27/80; CI 24-44%) of the offered A baits and 34% (27/80; CI 24-44%) of the offered C baits. For several offerings, the occurrence of spillage was unknown for both baits: 30% (24/80; CI 21-41%) for Bait A and 33% (26/80; CI 23-43%) for Bait C.

### 4. Conclusions

### 4.1. Round 1

The raccoons consumed the improved clear bait (Bait C). The raccoons did not exhibit any health issues related to consumption of the baits and no health issues were reported during the round nor in the week following the round.

The bait uptake was similar between the two baits. The same number (65%, 52/80; CI 54-74%) of A and B baits would be associated with dose delivery (≤50% of bait remaining); most of the raccoons (95%, 19/20; CI 76-99%) punctured at least one Bait A whereas as a slightly lower fraction (85%, 17/20; CI 64-95%) punctured at least one Bait B.

These results support the use of clear PBSA as used in Bait B, as a replacement for the plastic used in the standard sachet (Bait A).

### 4.2. Round 2

The raccoons consumed the metallic bait (Bait B). The raccoons did not exhibit any health issues related to consumption of the baits and no health issues were reported during the round nor in the week following the round.

The bait uptake was similar between the two baits. If 50% or less of the bait remaining resulted in dose delivery, 73% (58/80; CI 62-81%) of the A baits offered and 69% (55/80; CI 58-79%) of the C baits offered would be associated with dose delivery. Most of the raccoons (85%, 17/20; CI 64-95%) punctured at least one Bait A and a greater fraction (90%, 18/20; CI 70-97%) punctured at least one Bait C.

These results support use of the improved metallicized plastic as used in Bait C, as a replacement for the plastic used in the standard sachet (Bait A).

### 5. REFERENCES

Ayala, F., Zeta-Flores, M., Ramos-Baldárrago, S., Tume-Ruiz, J., Rangel-Vega, A., Reyes, E., Quinde, E., De-la-Torre, G. E., Lajo-Salazar, L., Cárdenas-Alayza, S., 2023. Terrestrial mammals of the Americas and their interactions with plastic waste. Environmental Science and Pollution Research 30, 57759-57770.
Bender, S., Bergman, D., Vos, A., Martin, A., Chipman, R., 2017. Field Studies Evaluating Bait Acceptance and Handling by Dogs in Navajo Nation, USA. Trop Med Infect Dis 2.
Horman, J. T., Shannon, K. V., Simpson, E. M., Burja, T. M., Fey, R. H., Smith, J. J., Phillips, F. B., 2012. Control of terrestrial animal rabies in Anne Arundel County, Maryland, after oral vaccination of raccoons (1998-2007). Journal of the American Veterinary Medical Association 241, 725-734.
Linhart, S. B., Wlodkowski, J. C., Kavanaugh, D. M., Motes-Kreimeyer, L., Montoney, A. J., Chipman, R. B., Slate, D., Bigler, L. L., Fearneyhough, M. G., 2002. A new flavor-coated sachet bait for delivering oral rabies vaccine to raccoons and coyotes. Journal of Wildlife Diseases 38, 363-377.
Lowry, R. 2023. The Confidence Interval of a Proportion. In VassarStats: Website for Statistical Computation. VassarStats: Statistical Computation Web Site Maki, J., Guiot, A. L., Aubert, M., Brochier, B., Cliquet, F., Hanlon, C. A., King, R., Oertli, E. H.,
Rupprecht, C. E., Schumacher, C., Slate, D., Yakobson, B., Wohlers, A., Lankau, E. W., 2017. Oral vaccination of wildlife using a vaccinia-rabies-glycoprotein recombinant virus vaccine (RABORAL V-RG®): a global review. Veterinary Research 48, 57.
Malizia, A., Monmany-Garzia, A. C., 2019. Terrestrial ecologists should stop ignoring plastic pollution in the Anthropocene time. Science of The Total Environment 668, 1025-1029.
R Core Team 2023. R: a language and environment for statistical computing, R Foundation for Statistical Computing, ed. (Vienna, Austria).
Slate, D., Algeo, T. P., Nelson, K. M., Chipman, R. B., Donovan, D., Blanton, J. D., Niezgoda, M., Rupprecht, C. E., 2009. Oral rabies vaccination in North America: opportunities, complexities, and challenges. PLOS Neglected Tropical Diseases 3, e549.
Wickham, H., 2016. ggplot2: Elegant graphis for data analysis. New York, Springer-Verlag.

### Example 5—Assessment of OraVet Original Packaging Vs c-PBSA Packaging

### 1. Methods and Results

OraVet® is a dental hygiene chew which uses a dual-action formula that helps protect and clean the dog's teeth. OraVet® chews contain delmopinol, an ingredient used in human oral care rinses. Delmopinol coats the teeth, preventing bacteria from attaching to the enamel, inhibiting plaque formation, and keeping the dog's mouth protected. When a dog bites into an OraVet®chew, the chewing action removes plaque on the teeth all the way down to the gumline. As this occurs, delmopinol is released and coats the teeth to help prevent bacterial attachment.

The texture properties are thus important. In order to compare how the c-PBSA packaging protects the chew against the external environment, two chews were sampled from their packaging each month. Each chew was subjected to three separate measurements, totaling six data points per packaging each month. The chews were periodically removed from a stability chamber maintained at 23° C., and a texture analysis was performed on each. Three groups were compared: original packaging, c-PBSA packaging and negative (without packaging).

During a Texture Profile Analysis (TPA) test samples are compressed twice using a texture analyzer to provide insight into how samples behave when chewed. The measured criteria were:
i. Hardness: peak resistive force during the first compression cycle;
ii. Adhesiveness: work required to overcome the attractive forces between the surface of a food and the surface of other materials;
iii. Cohesiveness: tendency of a product to cohere or stick together;
iv. Elasticity: the height that the food recovers during the time that elapses during the end of first bite and the start of the second bite;
v. Gumminess: amount of effort that goes into preparing a semi-solid food for swallowing; and
vi. Chewability: force required to chew solid food.

Each month, two chews were sampled from their packaging, each chew was subjected to three separate measurements, totaling six data points per packaging each month. The chews were periodically removed from a stability chamber maintained at 23° C., and a texture analysis was performed on each. Data for the above identified characteristics was collected over 4 months and sample t-tests were performed to compare the c-PBSA packaging, the original packaging, and the negative (without packaging).

### Results:

### Hardness:

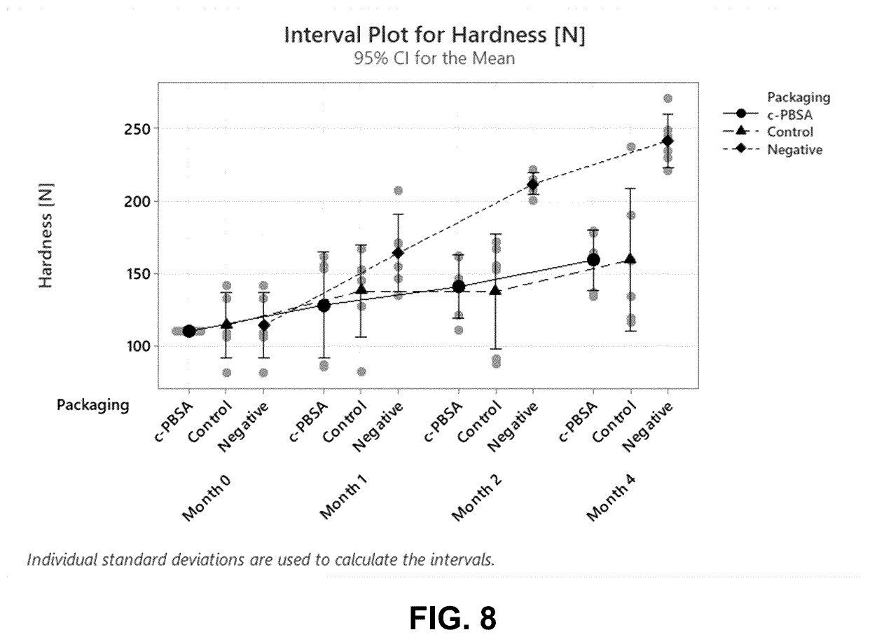

The hardness for the control packaging and c-PBSA packaging was analyzed using a Two-Sample T-test, and the confidence interval (CI) was calculated. No significant differences between the c-PBSA and original packaging were observed (FIG. 8). As shown in Table 26, the null hypothesis (H₀: μ₁−μ₂=0) indicates that the difference between the control and c-PBSA packaging is 0 for hardness. Because the p-value is 0.998 (which is more than the significance level of 0.05), the null hypothesis is not rejected and it is concluded that the hardness for the two packaging films are similar (Table 26 and FIG. 8).

TABLE 26
Comparison of the Data for the Chew in c-PBSA vs Control Packaging
μ₁: population mean of Control
μ₂: population mean of c-PBSA
Difference: μ₁ − μ₂
Equal variances were not assumed for this analysis
Descriptive Statistic

| Sample | N | Mean | StDev | SE Mean |
|---|---|---|---|---|
| Control | 6 | 159.3 | 47.0 | 19 |
| c-PBSA | 6 | 159.2 | 19.7 | 8.0 |

| | |
|---|---|
| Difference | 95% CI for Difference |

Estimation for Difference

| | |
|---|---|
| 0.1 | (−50.9, 51.0) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 0.00 | 6 | 0.998 |

The hardness for the c-PBSA packaging and the chew without packaging (negative) was analyzed using a Two-Sample T-test, and the confidence interval (CI) was calculated. As shown in FIG. 8, the hardness of the chew packaged in the c-PBSA film was significantly different from the chew without packaging (negative). As shown in Table 27, the null hypothesis (H₀: μ₁−μ₂=0) indicates that the difference between the c-PBSA and negative packaging is 0 for hardness. Because the p-value is 0.00 (which is less than the significance cut off value of 0.05), the null hypothesis is rejected and the hardness for the two packaging films differ (Table 27 and FIG. 8).

TABLE 27
Comparison of the Data for the Chew in c-PBSA vs Negative Packaging
μ₁: population mean of c-PBSA
μ₂: population mean of Negative
Difference: μ₁ − μ₂
Equal variances were not assumed for this analysis
Descriptive Statistic

| Sample | N | Mean | StDev | SE Mean |
|---|---|---|---|---|
| c-PBSA | 6 | 159.2 | 19.7 | 8.0 |
| Negative | 6 | 241.6 | 17.6 | 7.2 |

| | |
|---|---|
| Difference | 95% CI for Difference |

Estimation for Difference

| | |
|---|---|
| −82.3 | (−106.7, −58.0) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| −7.64 | 9 | 0.000 |

### Adhesiveness:

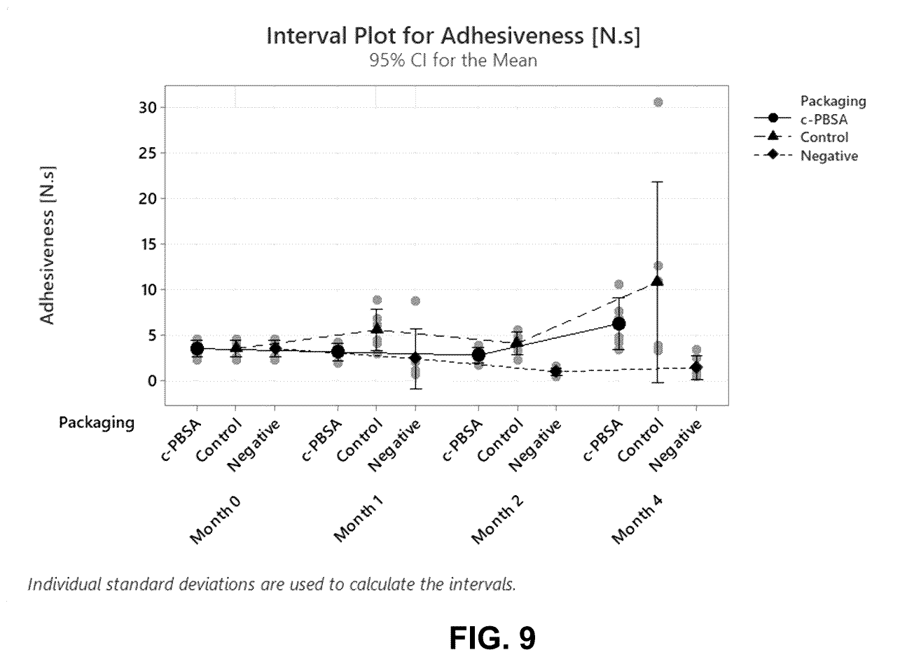

The adhesiveness for the control packaging and c-PBSA packaging was analyzed using a Two-Sample T-test, and the confidence interval (CI) was calculated. No significant differences in adhesiveness between the c-PBSA and original packaging were observed (FIG. 9). As shown in Table 28, the null hypothesis (H₀: μ₁−μ₂=0) indicates that the difference between the control and c-PBSA packaging is 0 for hardness. Because the p-value is 0.795 (which is more than the significance level of 0.05), the null hypothesis is not rejected and it is concluded that the adhesiveness for the two packaging films are similar (Table 28 and FIG. 9).

TABLE 28
Comparison of the Adhesivity for the
Chew in c-PBSA vs Control Packaging
μ₁: population mean of Control
μ₂: population mean of c-PBSA
Difference: μ₁ − μ₂
Equal variances were not assumed for this analysis
Descriptive Statistic

| Sample | N | Mean | StDev | SE Mean |
|---|---|---|---|---|
| Control | 5 | 6.89 | 4.53 | 2.0 |
| c-PBSA | 6 | 6.27 | 2.66 | 1.1 |

| | |
|---|---|
| Difference | 95% CI for Difference |

Estimation for Difference

| | |
|---|---|
| 0.62 | (−5.00, 6.24) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 0.27 | 6 | 0.795 |

The adhesiveness for the c-PBSA packaging and the chew without packaging (negative) was analyzed using a Two-Sample T-test, and the confidence interval (CI) was calculated. As shown in FIG. 9, the adhesiveness of the chew packaged in the c-PBSA film was significantly different from the chew without packaging (negative). As shown in Table 29, the null hypothesis (H₀: μ₁−μ₂=0) indicates that the difference between the c-PBSA and negative packaging is 0 for adhesiveness. Because the p-value is 0.005 (which is less than the significance cut off value of 0.05), the null hypothesis is rejected, and the adhesiveness for the two packaging films differ (Table 29 and FIG. 9).

TABLE 29
Comparison of the Adhesivity for the
Chew in c-PBSA vs Negative Packaging
μ₁: population mean of c-PBSA
μ₂: population mean of Negative
Difference: μ₁ − μ₂
Equal variances were not assumed for this analysis
Descriptive Statistic

| Sample | N | Mean | StDev | SE Mean |
|---|---|---|---|---|
| c-PBSA | 6 | 6.27 | 2.66 | 1.1 |
| Negative | 6 | 1.46 | 1.21 | 0.50 |

| | |
|---|---|
| Difference | 95% CI for Difference |

Estimation for Difference

| | |
|---|---|
| 4.81 | (1.99, 7.63) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 4.04 | 7 | 0.005 |

### Cohesiveness:

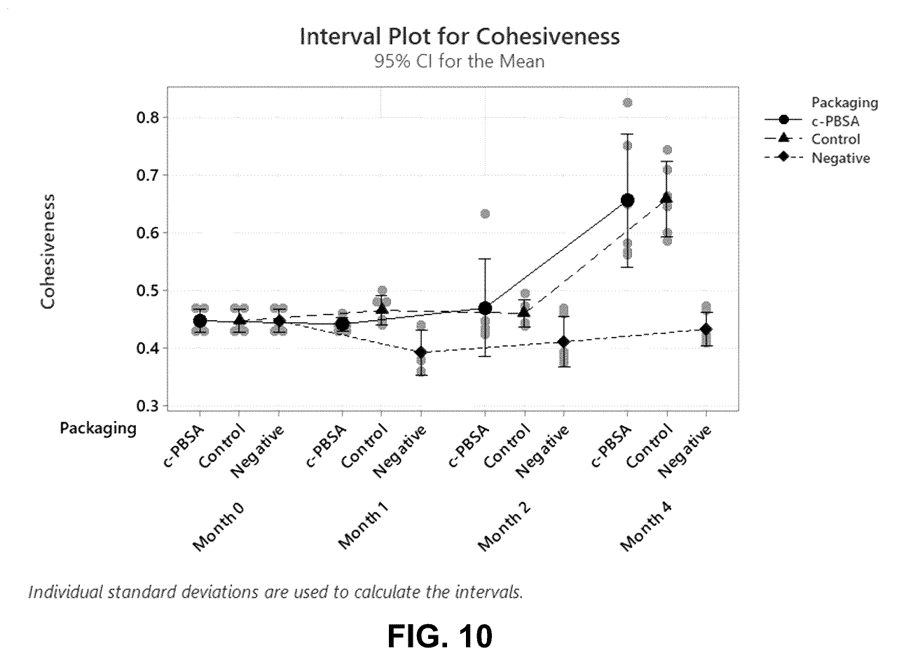

The cohesiveness for the control packaging and c-PBSA packaging was analyzed using a Two-Sample T-test, and the confidence interval (CI) was calculated. No significant differences in cohesiveness between the c-PBSA and original packaging were observed (FIG. 10). As shown in Table 30, the null hypothesis (H₀: μ₁−μ₂=0) indicates that the difference between the control and c-PBSA packaging is 0 for cohesiveness. Because the p-value is 0.968 (which is more than the significance level of 0.05), the null hypothesis is not rejected, and it is concluded that the cohesiveness for the two packaging films are similar (Table 30 and FIG. 10).

TABLE 30
Comparison of the Cohesiveness for the
Chew in c-PBSA vs Control Packaging
μ₁: population mean of Control
μ₂: population mean of c-PBSA
Difference: μ₁ − μ₂
Equal variances were not assumed for this analysis
Descriptive Statistic

| Sample | N | Mean | StDev | SE Mean |
|---|---|---|---|---|
| Control | 6 | 0.6583 | 0.0614 | 0.025 |
| c-PBSA | 6 | 0.656 | 0.110 | 0.045 |

| | |
|---|---|
| Difference | 95% CI for Difference |

Estimation for Difference

| | |
|---|---|
| 0.0021 | (−0.1192, 0.1234) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 0.04 | 7 | 0.968 |

The cohesiveness for the c-PBSA packaging and the chew without packaging (negative) was analyzed using a Two-Sample T-test, and the confidence interval (CI) was calculated. As shown in FIG. 10, the cohesiveness of the chew packaged in the c-PBSA film was significantly different from the chew without packaging (negative). As shown in Table 31, the null hypothesis (H₀: μ₁−μ₂=0) indicates that the difference between the c-PBSA and negative packaging is 0 for cohesiveness. Because the p-value is 0.005 (which is less than the significance cut off value of 0.05), the null hypothesis is rejected, and the cohesiveness for the two packaging films differ (Table 31 and FIG. 10).

TABLE 31
Comparison of the Cohesiveness for the
Chew in c-PBSA vs Negative Packaging
μ₁: population mean of c-PBSA
μ₂: population mean of Negative
Difference: μ₁ − μ₂
Equal variances were not assumed for this analysis
Descriptive Statistic

| Sample | N | Mean | StDev | SE Mean |
|---|---|---|---|---|
| c-PBSA | 6 | 0.656 | 0.110 | 0.045 |
| Negative | 6 | 0.4331 | 0.0285 | 0.012 |

| | |
|---|---|
| Difference | 95% CI for Difference |

Estimation for Difference

| | |
|---|---|
| 0.2231 | (0.1042, 0.3419) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 4.83 | 5 | 0.005 |

### Elasticity:

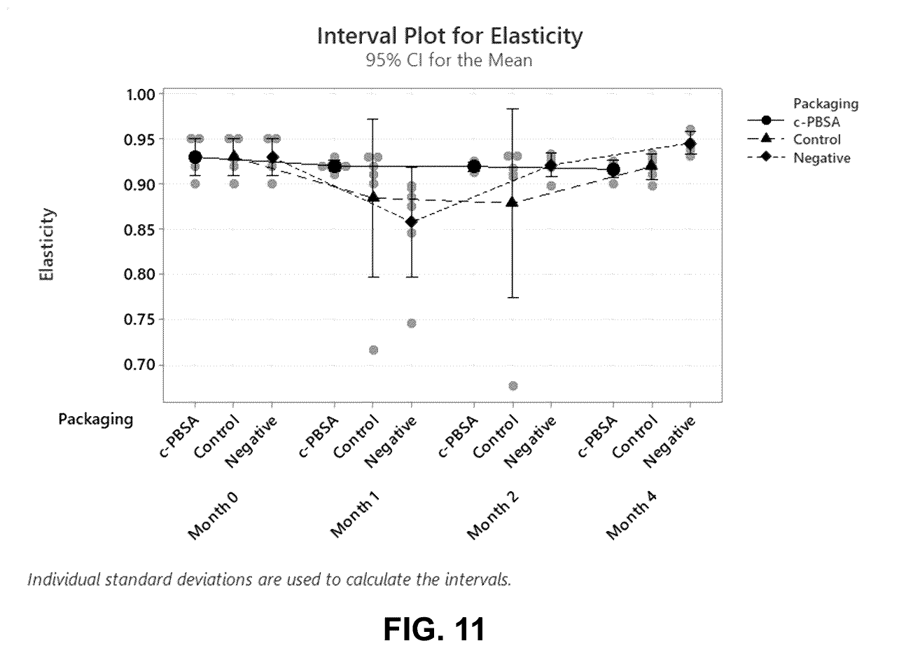

The elasticity for the control packaging and c-PBSA packaging was analyzed using a Two-Sample T-test, and the confidence interval (CI) was calculated. No significant differences in elasticity between the c-PBSA and original packaging were observed (FIG. 11). As shown in Table 32, the null hypothesis (H₀: μ₁−μ₂=0) indicates that the difference between the control and c-PBSA packaging is 0 for elasticity. Because the p-value is 0.669 (which is more than the significance level of 0.05), the null hypothesis is not rejected, and it is concluded that the elasticity for the two packaging films is similar (Table 32 and FIG. 11).

TABLE 32
Comparison of the Elasticity for the
Chew in c-PBSA vs Control Packaging
μ₁: population mean of Control
μ₂: population mean of c-PBSA
Difference: μ₁ − μ₂
Equal variances were not assumed for this analysis
Descriptive Statistic

| Sample | N | Mean | StDev | SE Mean |
|---|---|---|---|---|
| Control | 6 | 0.9192 | 0.0132 | 0.0054 |
| c-PBSA | 6 | 0.91625 | 0.00899 | 0.0037 |

| | |
|---|---|
| Difference | 95% CI for Difference |

Estimation for Difference

| | |
|---|---|
| 0.00290 | (−0.01216, 0.01796) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 0.44 | 8 | 0.669 |

The elasticity for the c-PBSA packaging and the chew without packaging (negative) was analyzed using a Two-Sample T-test, and the confidence interval (CI) was calculated. As shown in FIG. 11, the elasticity of the chew packaged in the c-PBSA film was significantly different from the chew without packaging (negative). As shown in Table 33, the null hypothesis (H₀: μ₁−μ₂=0) indicates that the difference between the c-PBSA and negative packaging is 0 for elasticity. Because the p-value is 0.001 (which is less than the significance cut off value of 0.05), the null hypothesis is rejected, and it is concluded that the elasticity for the two packaging films differ (Table 33 and FIG. 11).

TABLE 33
Comparison of the Elasticity for the
Chew in c-PBSA vs Negative Packaging
μ₁: population mean of c-PBSA
μ₂: population mean of Negative
Difference: μ₁ − μ₂
Equal variances were not assumed for this analysis
Descriptive Statistic

| Sample | N | Mean | StDev | SE Mean |
|---|---|---|---|---|
| c-PBSA | 6 | 0.91625 | 0.00899 | 0.0037 |
| Negative | 6 | 0.9453 | 0.0117 | 0.0048 |

| | |
|---|---|
| Difference | 95% CI for Difference |

Estimation for Difference

| | |
|---|---|
| −0.02902 | (−0.04263, −0.01542) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| −4.83 | 9 | 0.001 |

### Gumminess:

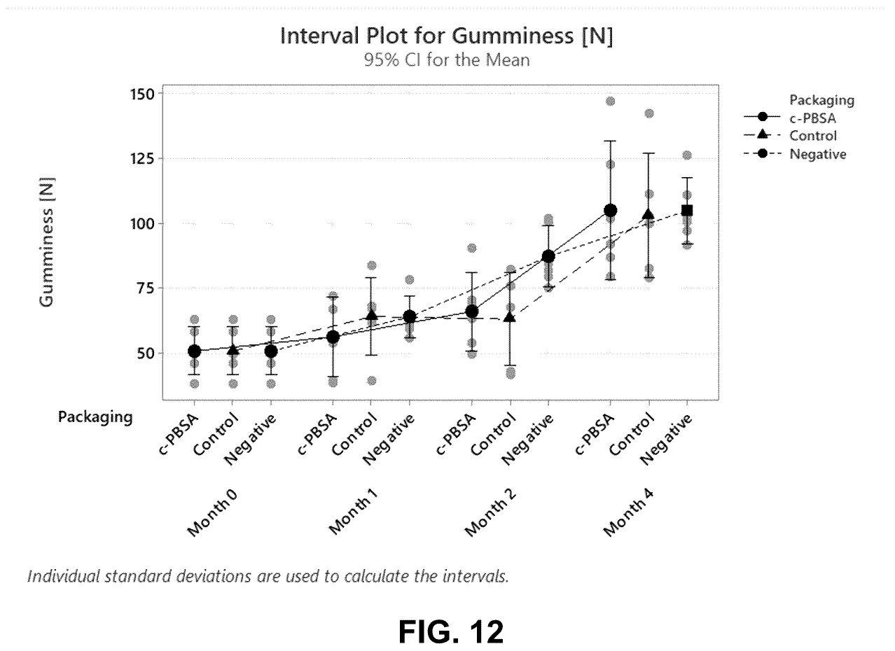

The gumminess for the control packaging and c-PBSA packaging was analyzed using a Two-Sample T-test, and the confidence interval (CI) was calculated. No significant differences in gumminess between the c-PBSA and original packaging were observed (FIG. 12). As shown in Table 34, the null hypothesis (H₀: μ₁−μ₂=0) indicates that the difference between the control and c-PBSA packaging is 0 for gumminess. Because the p-value is 0.886 (which is more than the significance level of 0.05), the null hypothesis is not rejected, and it is concluded that the gumminess for the two packaging films are similar (Table 34 and FIG. 12).

TABLE 34
Comparison of the Gumminess for the
Chew in c-PBSA vs Control Packaging
μ₁: population mean of Control
μ₂: population mean of c-PBSA
Difference: μ₁ − μ₂
Equal variances were not assumed for this analysis
Descriptive Statistic

| Sample | N | Mean | StDev | SE Mean |
|---|---|---|---|---|
| Control | 6 | 102.9 | 22.8 | 9.3 |
| c-PBSA | 6 | 105.0 | 25.4 | 10 |

| | |
|---|---|
| Difference | 95% CI for Difference |

Estimation for Difference

| | |
|---|---|
| −2.0 | (−33.5, 29.4) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| −0.15 | 9 | 0.886 |

The gumminess for the c-PBSA packaging and the chew without packaging (negative) was analyzed using a Two-Sample T-test, and the confidence interval (CI) was calculated. As shown in FIG. 12, the gumminess of the chew packaged in the c-PBSA film was not significantly different from the chew without packaging (negative). As shown in Table 35, the null hypothesis (H₀: μ₁−μ₂=0) indicates that the difference between the c-PBSA and negative packaging is 0 for gumminess. Because the p-value is 0.984 (which is more than the significance cut off value of 0.05), the null hypothesis is not rejected, and it is concluded that the gumminess between the c-PBSA packaging and the chew without packaging is similar (Table 35 and FIG. 12).

TABLE 35
Comparison of the Gumminess for the
Chew in c-PBSA vs Negative Packaging
μ₁: population mean of c-PBSA
μ₂: population mean of Negative
Difference: μ₁ − μ₂
Equal variances were not assumed for this analysis
Descriptive Statistic

| Sample | N | Mean | StDev | SE Mean |
|---|---|---|---|---|
| c-PBSA | 6 | 105.0 | 25.4 | 10 |
| Negative | 6 | 104.8 | 12.2 | 5.0 |

| | |
|---|---|
| Difference | 95% CI for Difference |

Estimation for Difference

| | |
|---|---|
| 0.2 | (−27.0, 27.4) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| 0.02 | 7 | 0.984 |

### Chewability:

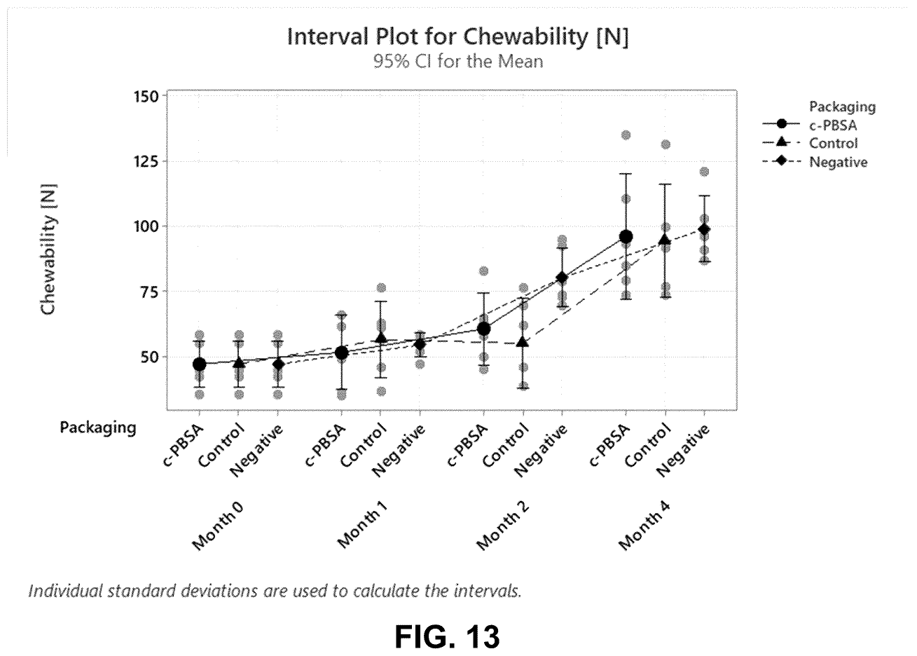

The chewability for the control packaging and c-PBSA packaging was analyzed using a Two-Sample T-test, and the confidence interval (CI) was calculated. No significant differences in chewability between the c-PBSA and original packaging were observed (FIG. 13). As shown in Table 36, the null hypothesis (H₀: μ₁−μ₂=0) indicates that the difference between the control and c-PBSA packaging is 0 for chewability. Because the p-value is 0.902 (which is more than the significance level of 0.05), the null hypothesis is not rejected, and it is concluded that the chewability for the two packaging films are similar (Table 36 and FIG. 13).

TABLE 36
Comparison of the Chewability for the
Chew in c-PBSA vs Control Packaging
μ₁: population mean of Control
μ₂: population mean of c-PBSA
Difference: μ₁ − μ₂
Equal variances were not assumed for this analysis
Descriptive Statistic

| Sample | N | Mean | StDev | SE Mean |
|---|---|---|---|---|
| Control | 6 | 94.5 | 20.7 | 8.5 |
| c-PBSA | 6 | 96.1 | 23.0 | 9.4 |

| | |
|---|---|
| Difference | 95% CI for Difference |

Estimation for Difference

| | |
|---|---|
| −1.6 | (−30.2, 27.0) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| −0.13 | 9 | 0.902 |

The chewability for the c-PBSA packaging and the chew without packaging (negative) was analyzed using a Two-Sample T-test, and the confidence interval (CI) was calculated. As shown in FIG. 13, the chewability of the chew packaged in the c-PBSA film was not significantly different from the chew without packaging (negative). As shown in Table 37, the null hypothesis (H₀: μ₁−μ₂=0) indicates that the difference between the c-PBSA and negative packaging is 0 for chewability. Because the p-value is 0.791 (which is more than the significance cut off value of 0.05), the null hypothesis is not rejected, and it is concluded that the chewability between the c-PBSA packaging and the chew without packaging is similar (Table 37 and FIG. 13).

TABLE 37
Comparison of the Chewability for the
Chew in c-PBSA vs Negative Packaging
μ₁: population mean of c-PBSA
μ₂: population mean of Negative
Difference: μ₁ − μ₂
Equal variances were not assumed for this analysis
Descriptive Statistic

| Sample | N | Mean | StDev | SE Mean |
|---|---|---|---|---|
| c-PBSA | 6 | 96.1 | 23.0 | 9.4 |
| Negative | 6 | 99.1 | 12.1 | 5.0 |

| | |
|---|---|
| Difference | 95% CI for Difference |

Estimation for Difference

| | |
|---|---|
| −2.9 | (−28.1, 22.2) |

Test

| | |
|---|---|
| Null hypothesis | H₀: μ₁ − μ₂ = 0 |
| Alternative hypothesis | H₁: μ₁ − μ₂ ≠ 0 |

| T-Value | DF | p-value |
|---|---|---|
| −0.28 | 7 | 0.791 |

The p-values for the characteristics tested are summarized in Table 38. c-PBSA packaging film was not significantly different from the control packaging, but was significantly different in hardness, adhesiveness, cohesiveness, and elasticity from the chew without packaging. Thus, the protection offered by the c-PBSA packaging is similar to that offered by the original packaging, and is significantly better than the chew without packaging.

TABLE 38
Summary of the p-Values for the Characteristics Tested

c-PBSA vs

| p- value | Control | Negative |
|---|---|---|
| Hardness | 0.998 | 0.000 |
| Adhesiveness | 0.795 | 0.005 |
| Cohesiveness | 0.968 | 0.005 |
| Elasticity | 0.669 | 0.001 |
| Gumminess | 0.886 | 0.984 |
| Chewability | 0.902 | 0.791 |

### 2. Conclusions

Based on the data obtained, no significant trends were observed for either the control (OraVet Packaging) or the c-PBSA packaged chews after two months of storage at 24° C. for the following assessments: hardness, cohesiveness, gumminess (rubberiness) and chewability. The c-PBSA chew exhibited a trend towards increased elasticity compared to the control chew, albeit no significant differences were observed. The c-PBSA chews demonstrated higher adhesiveness than the control chews at 4 months. The protection offered by the c-PBSA packaging is significantly better than the chew without packaging.

1. A biodegradable pouch for protecting a pharmaceutical formulation, comprising:
(a) a front composite material and a back composite material,
wherein the front and back composite materials are joined at a peripheral edge, forming an internal compartment,
wherein each of the front and back composite materials comprises:
(1) a top layer comprising cellophane;
(2) an adhesive layer comprising polyurethane; and
(3) a seal layer comprising polybutylene succinate adipate or polybutylene adipate terephthalate,
wherein the adhesive layer is between and in contact with each of the top layer and seal layer, wherein the adhesive is an aqueous-based adhesive, and
(b) the pharmaceutical formulation is in the internal compartment and is enclosed within the pouch.

2. The biodegradable pouch of claim 1, wherein the pharmaceutical formulation is in the form of a solid, optionally wherein the pharmaceutical formulation is a soft chew.

3. The biodegradable pouch of claim 1, wherein the pharmaceutical formulation is in the form of a liquid, optionally wherein the pharmaceutical formulation is a liquid vaccine.

4. A biodegradable pouch for protecting a liquid vaccine, comprising:
(a) a front composite material and a back composite material,
wherein the front and back composite materials are joined at a peripheral edge, forming an internal compartment,
wherein each of the front and back composite materials comprises:
(1) a top layer comprising cellophane;
(2) an adhesive layer comprising polyurethane; and
(3) a seal layer comprising polybutylene succinate adipate or polybutylene adipate terephthalate,
wherein the adhesive layer is between and in contact with each of the top layer and seal layer, wherein the adhesive is an aqueous-based adhesive, and
(b) the liquid vaccine is in the internal compartment and is enclosed within the pouch.

5. The biodegradable pouch of claim 1, wherein the top layer is a composite further comprising a top moisture barrier heat-seal coating on top of the cellophane, and optionally a bottom moisture barrier heat-seal coating on the bottom of the cellophane.

6. The biodegradable pouch of claim 5, wherein the top layer further comprises a metalized coating, wherein the metalized coating is on top of the top moisture barrier heat-seal coating.

7. The biodegradable pouch of claim 1, further comprising an outer coating comprising a bait material, such as bait made from a fruit, a vegetable, a nut butter (e.g., peanut butter), marshmallow, bacon, cat food, fish, or birdseed, or a combination thereof.

8. The biodegradable pouch of claim 7, wherein the outer coating comprises fish meal.

9. The biodegradable pouch of claim 1, wherein the top layer has a thickness ranging from about 10 μm to about 200 μm, from about 10 μm to about 150 μm, from about 10 μm to about 120 μm, from about 10 μm to about 100 μm, from about 10 μm to about 50 μm, from about 10 μm to about 30 μm, such as about 20 μm.

10. The biodegradable pouch of claim 1, wherein the seal layer has a thickness ranging from about 20 μm to about 100 μm, from about 20 μm to about 80 μm, from about 30 μm to about 100 μm, from about 30 μm to about 80 μm, from about 50 μm to about 100 μm, from about 50 μm to about 80 μm, such as about 60 μm.

11. The biodegradable pouch of claim 1, having a water vapor transmission rate (“WVTR”) of less than 10 g/m² per day, less than 8 g/m² per day, or less than 5 g/m² per day, such as about 7 g/m² per day, measured at 38° C., 90% relative humidity; and/or
an oxygen transmission rate (“OTR”) of at least 10 cc/m² per day, at least 12 cc/m² per day, at least 15 cc/m² per day, at least 20 cc/m² per day, at least 25 cc/m² per day, or at least 30 cc/m² per day, measured at 23.3° C., 0% relative humidity.

12. The biodegradable pouch of claim 1, wherein the pharmaceutical formulation is a liquid rabies vaccine.

13. The biodegradable pouch of claim 1, wherein the weight loss of the biodegradable pouch is less than 15%, less than 12%, or less than 8%, following storage for at least 7 days, at least 14 days, or at least 21 days, at about 30° C. and 1 atm; or
following storage for at least 1 month, at least 3 months, at least 6 months, at least 9 months, at least 12 months, at least 18 months, or at least 24 months, at about 5° C. and 1 atm.

14. The biodegradable pouch of claim 3, wherein the pH value and/or VRG titer of the liquid vaccine has a change of less than 1, less than 0.9, less than 0.8, less than 0.7, less than 0.6, less than 0.5, less than 0.4, less than 0.3, less than 0.2, or less than 0.1,
following storage for at least 7 days, at least 14 days, or at least 21 days, at about 30° C. and 1 atm; or
following storage for at least 1 month, at least 3 months, at least 6 months, at least 9 months, at least 12 months, at least 18 months, or at least 24 months, at about 5° C. and 1 atm.

15. The biodegradable pouch of claim 3, wherein the liquid vaccine has an osmolality of less than 600 mOsm/kg, less than 550 mOsm/kg, less than 500 mOsm/kg, less than 450 mOsm/kg, less than 400 mOsm/kg, less than 350 mOsm/kg, or less than 300 mOsm/kg,
following storage for at least 7 days, at least 14 days, or at least 21 days, at about 30° C. and 1 atm; or
following storage for at least 1 month, at least 3 months, at least 6 months, at least 9 months, at least 12 months, at least 18 months, or at least 24 months, at about 5° C. and 1 atm.

16. A method for vaccinating a wild animal, comprising: distributing the biodegradable pouch of claim 1 in an environment.

17. The method of claim 16, wherein the biodegradable pouches are distributed at a density ranging from about 50 baits/km² to about 200 baits/km².

18. The method of claim 16, wherein the wild animal is a racoon.

19. The method of claim 16, wherein the biodegradable pouch is distributed in a forest or a neighborhood.
